(19) United States
(12) Patent Application Publication
(10) Pub. No.: US 2009/0282308 A1
(43) Pub. Date: Nov. 12, 2009

(54) Memory Cell Arrangement and Method for Reading State Information From a Memory Cell Bypassing an Error Detection Circuit

(76) Inventors: Jan Gutsche, Munich (DE); Michael Scheppler, Munich (DE); Detlev Richter, Munich (DE); Doris Keitel Schulz, Hoehenkirchen (DE); Helmut Schwalm, Karlskron (DE)

Correspondence Address: SLATER & MATSIL, L.L.P., 17950 PRESTON ROAD, SUITE 1000, DALLAS, TX, 75252, US

(21) Appl. No.: 12/118,560

(22) Filed: May 9, 2008

(51) Int. Cl. G06F 11/07

(52) U.S. Cl. 714/746; 714/E11.023

(57) ABSTRACT

In an embodiment, an integrated circuit having a memory cell arrangement is provided. The memory cell arrangement may include at least one memory cell, at least one error detection circuit, and a controller configured to control a read operation to read state information from the at least one memory cell by reading a memory cell state information bypassing the at least one error correction circuit, or by reading the memory cell state information and supplying it to the at least one error correction circuit.

### TECHNICAL FIELD

Embodiments relate generally to memory cell arrangements and methods for reading state information from a memory cell bypassing an error detection circuit.

### BACKGROUND

With the continuing shrinking of the dimensions of memory cells (e.g., non-volatile memory cells) and with the introduction of multi-bit memory cells or multi-level memory cells to store a plurality of bits of information in one respective memory cell, the failure probability of bits stored in the memory cells will increase.

One countermeasure to address the increased bit failures might be to enhance the error correction capability within a memory cell arrangement including the memory cells. In this context, it is to be understood that the stronger and thus usually more complex an error correction process is, the higher usually the latency will be expected to be in reading state information from a memory cell.

However, latency may become an important parameter, e.g., in the comparison of a solid state disc (SDD) with a hard disc drive (HDD), and therefore will probably gain more and more attention in a memory cell arrangement.

In a conventional memory cell arrangement, an error correction process (ECC) is applied at every read access to a memory cell.

### SUMMARY OF THE INVENTION

In an embodiment, an integrated circuit having a memory cell arrangement is provided. The memory cell arrangement may include at least one memory cell, at least one error correction circuit, and a controller configured to control a read operation to read state information from the at least one memory cell by reading a memory cell state information bypassing the at least one error correction circuit, or by reading the memory cell state information and supplying it to the at least one error correction circuit.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of embodiments of the invention. In the following description, various embodiments of the invention are described with reference to the following drawings, in which:

FIG. 1 shows a computer system having a memory cell arrangement in accordance with an embodiment;

FIG. 2 shows a memory of FIG. 1 in accordance with an embodiment;

FIG. 3 shows an example of a memory cell arrangement controller of FIG. 1 in more detail;

FIG. 4 shows another example of a memory cell arrangement controller of FIG. 1 in more detail;

FIG. 5 shows an example of the memory cell field of FIG. 2 in accordance with an embodiment;

FIG. 6 shows a portion of an example of a memory cell arrangement in accordance with an embodiment illustrating a data flow during a read operation;

FIG. 7 shows an endurance failure diagram and a latency diagram in accordance with an embodiment;

FIG. 8 shows an overview representation of various latency representations in accordance with an embodiment;

FIG. 9 shows a first latency diagram in accordance with an embodiment;

FIGS. 10A and 10B show a second latency diagram (FIG. 10A) and an assigned average latency diagram (FIG. 10B) in accordance with an embodiment;

FIGS. 11A and 11B show a third latency diagram (FIG. 11A) and an assigned average latency diagram (FIG. 11B) in accordance with an embodiment;

FIGS. 12A and 12B show a fourth latency diagram (FIG. 12A) and an assigned average latency diagram (FIG. 12B) in accordance with an embodiment;

FIGS. 13A and 13B show a fifth latency diagram (FIG. 13A) and an assigned average latency diagram (FIG. 13B) in accordance with an embodiment;

FIG. 14 shows another example of a memory cell arrangement of FIG. 1;

FIG. 15 shows a method for reading a state information in a memory cell arrangement of an integrated circuit in accordance with an embodiment;

FIG. 16 shows a method for reading a state information in a memory cell arrangement of an integrated circuit in accordance with another embodiment;

FIG. 17 shows a method for reading a state information in a memory cell arrangement of an integrated circuit in accordance with yet another embodiment;

FIG. 18 shows a failure class diagram in accordance with an embodiment;

FIG. 19 shows a memory of FIG. 1 in accordance with another embodiment;

FIG. 20 shows a memory cell arrangement of FIG. 1 in accordance with another embodiment; and

FIGS. 21A and 21B show a memory module (FIG. 21A) and a stackable memory module (FIG. 21B) in accordance with an embodiment.

### DETAILED DESCRIPTION OF ILLUSTRATIVE EMBODIMENTS

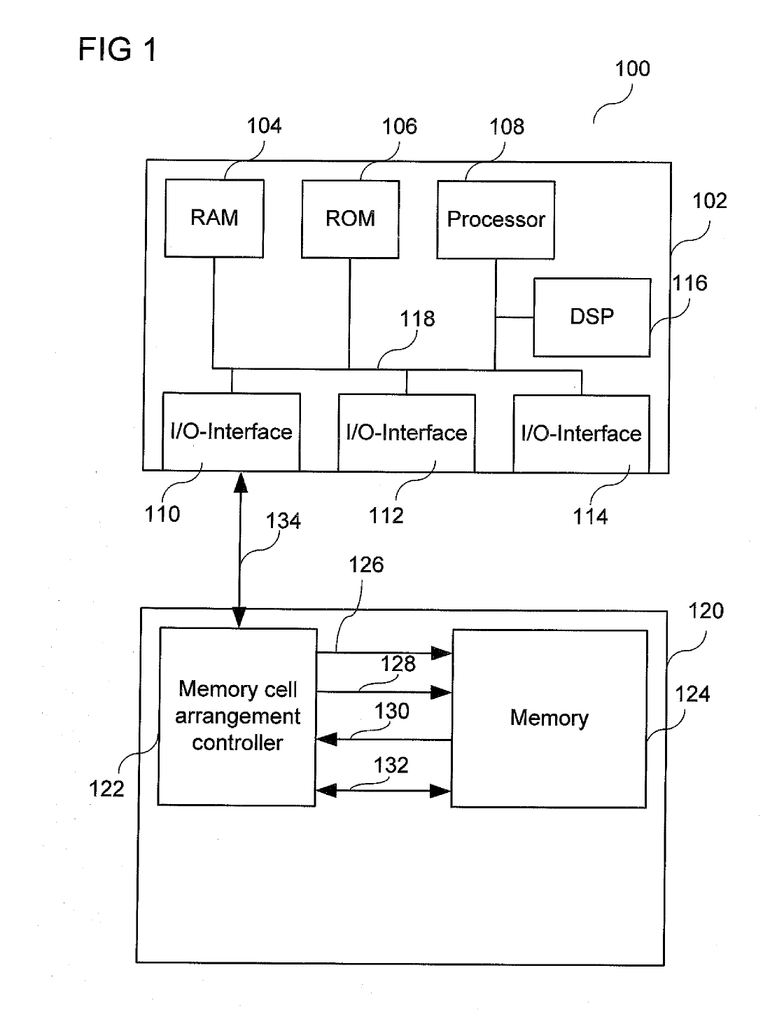

FIG. 1 shows a computer system 100 having a computer arrangement 102 and a memory cell arrangement 120 in accordance with an embodiment.

In various embodiments, the computer arrangement 102 may be configured as or may include any device having a processor, e.g., having a programmable processor such as, e.g., a microprocessor (e.g., a CISC (complex instruction set computer) microprocessor or a RISC (reduced instruction set computer) microprocessor). In various embodiments, the computer arrangement 102 may be configured as or may include a personal computer, a workstation, a laptop, a notebook, a personal digital assistant (PDA), a radio telephone (e.g., a wireless radio telephone or a mobile radio telephone), a camera (e.g., an analog camera or a digital camera), or another device having a processor (such as, e.g., a household appliance (such as, e.g., a washing machine, a dishwashing machine, etc.))

In an embodiment, the computer arrangement 102 may include one or a plurality of computer arrangement-internal random access memories (RAM) 104, e.g., one or a plurality of computer arrangement-internal dynamic random access memories (DRAM), in which, for example, data to be processed may be stored. Furthermore, the computer arrangement 102 may include one or a plurality of computer arrangement-internal read only memories (ROM) 106, in which, for example, the program code may be stored, which should be executed by a processor 108 (e.g., a processor as described above), which may also be provided in the computer arrangement 102.

Furthermore, in an embodiment, one or a plurality of input/output interfaces 110, 112, 114 (in FIG. 1, there are shown three input/output interfaces, in alternative embodiments, e.g., one, two, four, or even more than four input/output interfaces may be provided) configured to connect one or a plurality of computer arrangement-external devices (such as, e.g., additional memory, one or a plurality of communication devices, one or a plurality of additional processors) to the computer arrangement 102, may be provided in the computer arrangement 102.

The input/output interfaces 110, 112, 114 may be implemented as analog interfaces and/or as digital interfaces. The input/output interfaces 110, 112, 114 may be implemented as serial interfaces and/or as parallel interfaces. The input/output interfaces 110, 112, 114 may be implemented as one or a plurality of circuits, which implements or implement a respective communication protocol stack in its functionality in accordance with the communication protocol which is respectively used for data transmission. Each of the input/output interfaces 110, 112, 114 may be configured in accordance with any communication protocol. In an embodiment, each of the input/output interfaces 110, 112, 114 may be implemented in accordance with one of the following communication protocols:
an ad hoc communication protocol such as, e.g., Firewire or Bluetooth;
a communication protocol for a serial data transmission such as, e.g., RS-232, Universal Serial Bus (USB) (e.g., USB 1.0, USB 1.1, USB 2.0, USB 3.0);
any other communication protocol such as, e.g., Infrared Data Association (IrDA).

In an embodiment, the first input/output interface 110 is a USB interface (in alternative embodiments, the first input/output interface 110 may be configured in accordance with any other communication protocol such as, e.g., in accordance with a communication protocol which has been described above).

In an embodiment, the computer arrangement 102 optionally may include an additional digital signal processor (DSP) 116, which may be provided, e.g., for digital signal processing. Furthermore, the computer arrangement 102 may include additional communication modules (not shown) such as, e.g., one or a plurality of transmitters, one or a plurality of receivers, one or a plurality of antennas, and so on.

The computer arrangement 102 may also include additional components (not shown), which are desired or required in the respective application.

In an embodiment, some or all of the circuits or components provided in the computer arrangement 102 may be coupled with each other by means of one or a plurality of computer arrangement-internal connections 118 (for example, by means of one or a plurality of computer busses) configured to transmit data and/or control signals between the respectively coupled circuits or components.

Furthermore, as has been described above, the computer system 100, in accordance with an embodiment, may include the memory cell arrangement 120.

The memory cell arrangement 120 may in an embodiment be configured as an integrated circuit. The memory cell arrangement 120 may further be provided in a memory module having a plurality of integrated circuits, wherein at least one integrated circuit of the plurality of integrated circuits includes a memory cell arrangement 120, as will be described in more detail below. The memory module may be a stackable memory module, wherein some of the integrated circuit may be stacked one above the other. In an embodiment, the memory cell arrangement 120 is configured as a memory card.

In an embodiment, the memory cell arrangement 120 may include a memory cell arrangement controller 122 (for example, implemented by means of hard wired logic and/or by means of one or a plurality of programmable processors, e.g., by means of one or a plurality of programmable processors such as, e.g., one or a plurality of programmable microprocessors (e.g. CISC (complex instruction set computer) microprocessor(s) or RISC (reduced instruction set computer) microprocessor(s)).

The memory cell arrangement 120 may further include a memory 124 having a plurality of memory cells. The memory 124 will be described in more detail below.

In an embodiment, the memory cell arrangement controller 122 may be coupled with the memory 124 by means of various connections. Each of the connections may include one or a plurality of lines and may thus have a bus width of one or a plurality of bits. Thus, by way of example, an address bus 126 may be provided, by means of which one or a plurality of addresses of one or a plurality of memory cells may be provided by the memory cell arrangement controller 122 to the memory 124, on which an operation (e.g., an erase operation, a write operation, a read operation, an erase verify operation, or a write verify operation, etc.) should be carried out. Furthermore, a data write connection 128 may be provided, by means of which the information to be written into the respectively addressed memory cell may be supplied by the memory cell arrangement controller 122 to the memory 124. Furthermore, a data read connection 130 may be provided, by means of which the information stored in the respectively addressed memory cell may be read out of the memory 124 and may be supplied from the memory 124 to the memory cell arrangement controller 122 and via the memory cell arrangement controller 122 to the computer arrangement 102, or, alternatively, directly to the computer arrangement 102 (in which case the first input/output interface 110 would directly be connected to the memory 124). A bidirectional control/state connection 132 may be used for providing control signals from the memory cell arrangement controller 122 to the memory 124 or for supplying state signals representing the state of the memory 124 from the memory 124 to the memory cell arrangement controller 122.

In an embodiment, the memory cell arrangement controller 122 may be coupled to the first input/output interface 110 by means of a communication connection 134 (e.g., by means of a USB communication connection).

In an embodiment, the memory 124 may include one chip or a plurality of chips. Furthermore, the memory cell arrangement controller 122 may be implemented on the same chip (or die) as the components of the memory 124 or on a separate chip (or die).

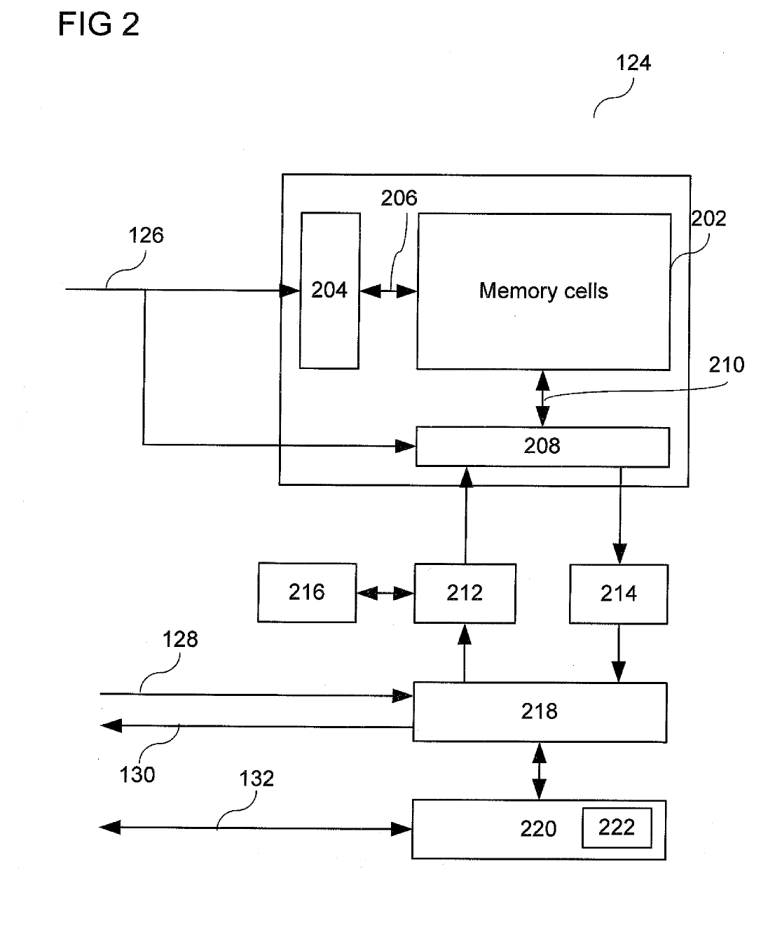

FIG. 2 shows the memory 124 of FIG. 1 in accordance with an embodiment in more detail.

In an embodiment, the memory 124 may include a memory cell field (e.g. a memory cell array) 202 having a plurality of memory cells. The memory cells may be arranged in the memory cell field 202 in the form of a matrix in rows and columns, or, alternatively, for example, in zig zag form. In other embodiments, the memory cells may be arranged within the memory cell field 202 in any other manner or architecture.

In general, each memory cell may, for example, be coupled with a first control line (e.g. a word line) and with at least one second control line (e.g., at least one bit line).

In an embodiment, in which the memory cells are arranged in the memory cell field 202 in the form of a matrix in rows and columns, a row decoder circuit 204 configured to select at least one row control line (e.g., a word line) of a plurality of row control lines 206 in the memory cell field 202 may be provided as well as a column decoder circuit 208 configured to select at least one column control line (e.g., a bit line) of a plurality of column control lines 210 in the memory cell field 202.

In an embodiment, the memory cells are non-volatile memory cells.

A “non-volatile memory cell” may be understood as a memory cell storing data even if it is not active. In an embodiment, a memory cell may be understood as being not active, e.g., if currently access to the content of the memory cell is inactive. In another embodiment, a memory cell may be understood as being not active, e.g., if the power supply is inactive. Furthermore, the stored data may be refreshed on a regular timely basis, but not, as with a “volatile memory cell” every few picoseconds or nanoseconds or milliseconds, but rather in a range of hours, days, weeks or months. Alternatively, the data may not need to be refreshed at all in some designs.

The non-volatile memory cells may be memory cells selected from a group of memory cells consisting, e.g., of:
charge storing random access memory cells (e.g., floating gate memory cells or charge trapping memory cells);
ferroelectric random access memory cells (FeRAM, FRAM);
magnetoresistive random access memory cells (MRAM);
phase change random access memory cells (PCRAM, for example, so called Ovonic Unified Memory(OUM) memory cells);
conductive filament random access memory cells (e.g., conductive bridging random access memory cells (CBRAM), also referred to as programmable metallization cells (PMC), or carbon-based conductive filament random access memory cells);
organic random access memory cells (ORAM);
nanotube random access memory cells (NRAM) (e.g., carbon nanotube random access memory cells);
nanowire random access memory cells.

In alternative embodiments, also other types of non-volatile memory cells may be used.

In various embodiments, the memory cells may be resistive memory cells.

Furthermore, the memory cells may be electrically erasable read only memory cells (EEPROM).

In an embodiment, the memory cells may be Flash memory cells, e.g., charge storing memory cells such as, e.g., floating gate memory cells or charge trapping memory cells.

In an embodiment, each charge trapping memory cell includes a charge trapping layer structure for trapping electrical charge carriers. The charge trapping layer structure may include one or a plurality of two separate charge trapping regions. In an embodiment, the charge trapping layer structure includes a dielectric layer stack including at least one dielectric layer or at least two dielectric layers being formed above one another, wherein charge carriers can be trapped in at least one dielectric layer. By way of example, the charge trapping layer structure includes a charge trapping layer, which may include or consist of one or more materials being selected from a group of materials that consists of: aluminum oxide (Al₂O₃), yttrium oxide (Y₂O₃), hafnium oxide (HfO₂), lanthanum oxide (LaO₂), zirconium oxide (ZrO₂), amorphous silicon (a-Si), tantalum oxide (Ta₂O₅), titanium oxide (TiO₂), and/or an aluminate. An example for an aluminate is an alloy of the components aluminum, zirconium and oxygen (AlZrO). In one embodiment, the charge trapping layer structure includes a dielectric layer stack including three dielectric layers being formed above one another, e.g., a first oxide layer (e.g., silicon oxide), a nitride layer as charge trapping layer (e.g., silicon nitride) on the first oxide layer, and a second oxide layer (e.g., silicon oxide or aluminum oxide) on the nitride layer. This type of dielectric layer stack is also referred to as ONO layer stack. In an alternative embodiment, the charge trapping layer structure includes two, four or even more dielectric layers being formed above one another.

In an embodiment, the memory cells may be multi-bit memory cells. As used herein the term “multi-bit” memory cell is intended to, e.g., include memory cells which are configured to store a plurality of bits by spatially separated electric charge storage regions or current conductivity regions, thereby representing a plurality of logic states.

In another embodiment, the memory cells may be multi-level memory cells. As used herein the term “multi-level” memory cell is intended to, e.g., include memory cells which are configured to store a plurality of bits by showing distinguishable voltage or current levels dependent on the amount of electric charge stored in the memory cell or the amount of electric current flowing through the memory cell, thereby representing a plurality of logic states.

In an embodiment, address signals are supplied to the row decoder circuit 204 and the column decoder circuit 208 by means of the address bus 126, which is coupled to the row decoder circuit 204 and to the column decoder circuit 208. The address signals uniquely identify at least one memory cell to be selected for an access operation (e.g., for one of the above described operations). The row decoder circuit 204 selects at least one row and thus at least one row control line 206 in accordance with the supplied address signal. Furthermore, the column decoder circuit 208 selects at least one column und thus at least one column control line 210 in accordance with the supplied address signal.

The electrical voltages that are provided in accordance with the selected operation, e.g., for reading, programming (e.g., writing) or erasing of one memory cell or of a plurality of memory cells, are applied to the selected at least one row control line 206 and to the at least one column control line 210.

In the case that each memory cell is configured in the form of a field effect transistor (e.g., in the case of a charge storing memory cell), in an embodiment, the respective gate terminal is coupled to the row control line 206 and a first source/drain terminal is coupled to a first column control line 210. A second source/drain terminal may be coupled to a second column control line 210. Alternatively, with a first source/drain terminal of an adjacent memory cell, which may then, e.g., also be coupled to the same row control line 206 (this is the case, e.g., in a NAND arrangement of the memory cells in the memory cell field 202).

In an embodiment, by way of example, for reading or for programming, a single row control line 206 and a single column control line 210 are selected at the same time and are appropriately driven for reading or programming of the thus selected memory cell. In an alternative embodiment, it may be provided to respectively select a single row control line 206 and a plurality of column control lines 210 at the same time for reading or for programming, thereby allowing to read or program a plurality of memory cells at the same time.

Furthermore, in an embodiment, the memory 124 includes at least one write buffer memory 212 and at least one read buffer memory 214. The at least one write buffer memory 212 and the at least one read buffer memory 214 are coupled with the column decoder circuit 208. Depending on the type of memory cell, reference memory cells 216 may be provided for reading the memory cells.

In order to program (e.g., write) a memory cell, the data to be programmed may be received by a data register 218, which is coupled with the data write connection 128, by means of the data write connection 128, and may be buffered in the at least one write buffer memory 212 during the write operation.

In order to read a memory cell, the data read from the addressed memory cell (represented, e.g., by means of an electrical current, which flows through the addressed memory cell and the corresponding column control line 210, which may be compared with a current threshold value in order to determine the content of the memory cell, wherein the current threshold value may, e.g., be dependent from the reference memory cells 216) are, e.g., buffered in the read buffer memory 214 during the read operation. The result of the comparison und therewith the logic state of the memory cell (wherein the logic state of the memory cell represents the memory content of the memory cell) may then be stored in the data register 218 and may be provided via the data read connection 130, with which the data register 218 may be coupled.

The access operations (e.g., write operations, read operations, or erase operations) may be controlled by a memory-internal controller 220, which in turn may be controlled by the memory cell arrangement controller 122 by means of the bidirectional control/state connection 132. In an alternative embodiment, the data register 218 may directly be connected to the memory cell arrangement controller 122 by means of the bidirectional control/state connection 132 and thus directly controlled thereby. In this example, the memory-internal controller 220 may be omitted. In an example, the memory-internal controller 220 may include a memory-internal internal error detection circuit and/or a memory-internal error correction circuit 222, as will be described in more detail below. In an example, the memory-internal controller 220 (which may be implemented as an ARM controller, for example) may include a Tightly Coupled Memory (TCM) circuit (e.g., a memory which resides directly on a processor, e.g., the memory-internal controller 220), which in turn may include a memory-internal error detection circuit and/or a memory-internal error correction circuit 222, e.g., a parity-check error detection circuit and/or a parity-check error correction circuit.

In an embodiment, the memory cells of the memory cell field may be grouped into memory blocks or memory sectors, which may be commonly erased in an erase operation. In an embodiment, there are so many memory cells included in a memory block or memory sector such that the same amount of data may be stored therein as compared with a conventional hard disk memory sector (e.g., 512 byte), although a memory block or memory sector may alternatively also store another amount of data.

Furthermore, other common memory components (e.g., peripheral circuits such as, e.g., charge pump circuits, etc.) may be provided in the memory 124, but they are neither shown in FIG. 1 nor FIG. 2 for reasons of clarity.

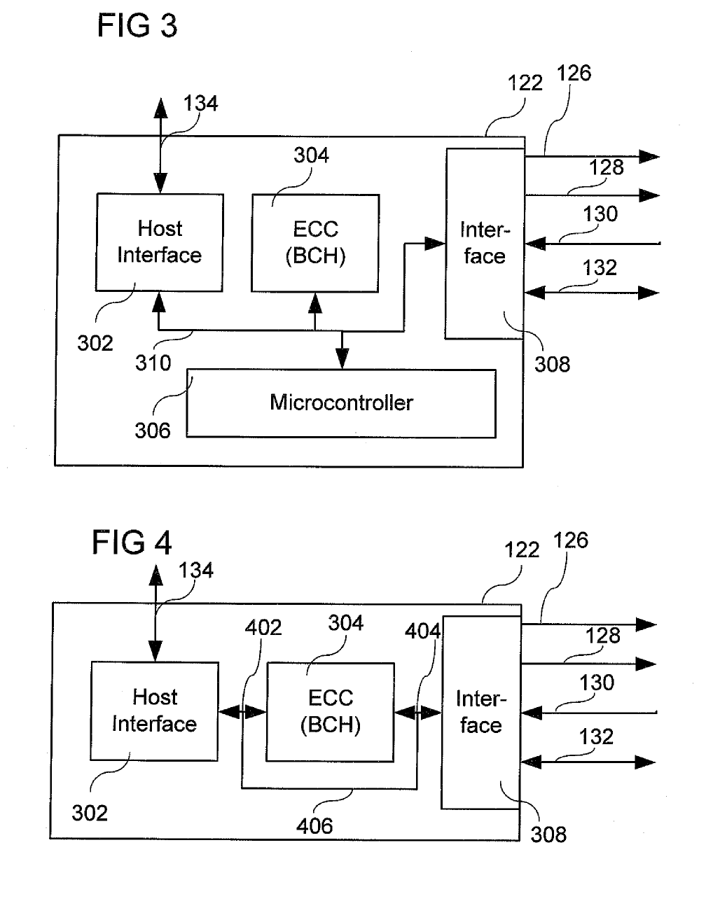

FIG. 3 shows an example of the memory cell arrangement controller 122 of FIG. 1 in more detail.

In this example, the memory cell arrangement controller 122 may include a host interface circuit 302 which serves as an interface to the computer arrangement 102, for example. In general, the host interface circuit 302 is configured to provide a communication interface to a memory cell arrangement-external device. Furthermore, the memory cell arrangement controller 122 may include one or more error detection circuits and/or one or more error correction circuits (in FIG. 3 symbolized by one block 304), a processor 306, e.g., a programmable processor such as, e.g., a microprocessor, and a memory interface circuit 308. The memory interface circuit 308 is configured to provide a communication interface e.g. to the above-mentioned connections to the memory 124 (e.g., to the address bus 126, the data write connection 128, the data read connection 130, and the control/state connection 132). In an example, a memory cell arrangement controller-internal connection (e.g., a memory cell arrangement controller-internal bus) 310 is provided, to which host interface circuit 302, the one or more error detection circuits and/or one or more error correction circuits 304, the processor 306, and the memory interface circuit 308 are connected for exchanging signals. It should be mentioned that in an alternative example, the one or more error detection circuits and/or one or more error correction circuits 304 may be implemented in the processor 306.

FIG. 4 shows an example of the memory cell arrangement controller 122 of FIG. 1 in more detail.

The memory cell arrangement controller 122 of FIG. 4 differs from the memory cell arrangement controller 122 of FIG. 3, e.g., in that the host interface circuit 302 (which may in turn include a processor), the one or more error detection circuits and/or one or more error correction circuits 304, and the memory interface circuit 308 are coupled with each other in series (e.g., by means of serial connections 402, 404). Furthermore, the processor 306 may be omitted or may be implemented in the host interface circuit 302 and/or in the one or more error detection circuits and/or one or more error correction circuits 304. Furthermore, an ECC bypass connection 406 may be provided which directly connects the host interface circuit 302 with the memory interface circuit 308 and thus directly, e.g., with the data read connection 130. In this way, the ECC bypass connection 406 illustratively may provide a bypass path bypassing at least one of the one or more error detection circuits and/or one or more error correction circuits 304, as will be described in more detail below.

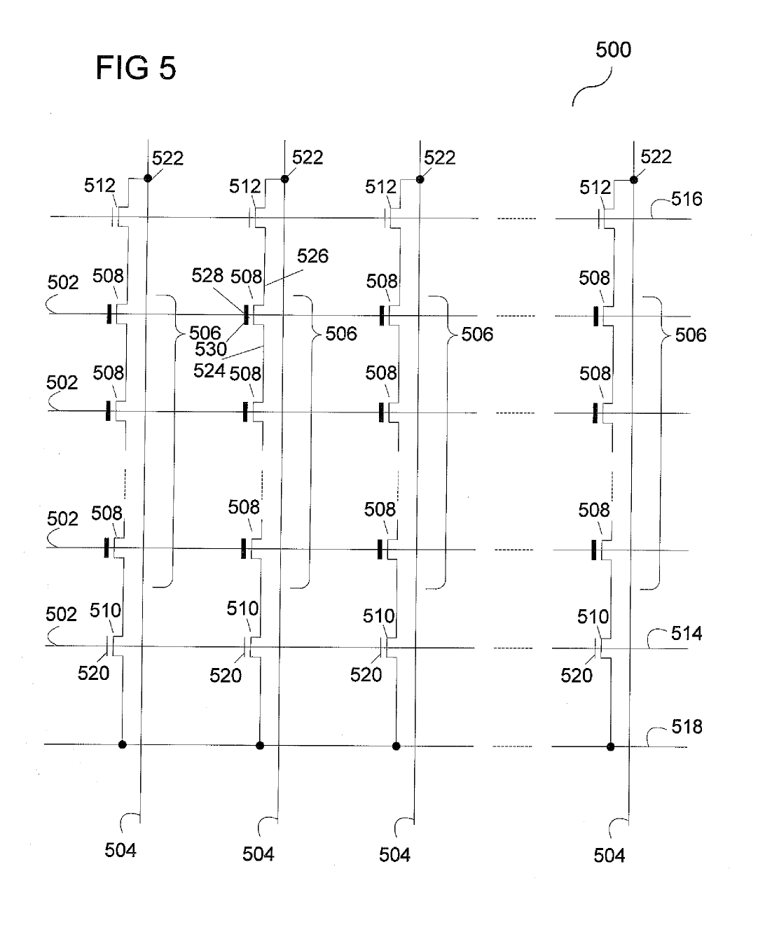

FIG. 5 shows a memory cell portion 500 of the memory cell field 202 in accordance with an embodiment.

In one embodiment, the memory cell portion 500 is arranged as a NAND memory cell field (although another coupling architecture may be provided in an alternative embodiment).

In an embodiment, the NAND memory cell portion 500 (e.g., a NAND memory cell array portion 500) may include word lines 502 (in general, an arbitrary number of word lines 502, in one embodiment, 1024 word lines 502) and intersecting bit lines 504 (in general, an arbitrary number of bit lines 504, in one embodiment, 512 bit lines 504).

The NAND memory cell array portion 500 may include NAND strings 506, each NAND string 506 having memory cells 508 (e.g., charge storing memory cells 508 such as, e.g., charge trapping memory cells 508 or floating gate memory cells 508). Furthermore, an arbitrary number of memory cells 508 can be provided in the NAND string 506, in accordance with one embodiment, 32 memory cells 508. The memory cells 508 are connected in series source-to-drain between a source select gate 510, which may be implemented as a field effect transistor, and a drain select gate 512, which may also be implemented as a field effect transistor. Each source select gate 510 is positioned at an intersection of a bit line 504 and a source select line 514. Each drain select gate 512 is positioned at an intersection of a bit line 504 and a drain select line 516. The drain of each source select gate 510 is connected to the source terminal of the first charge trapping memory cells 508 of the corresponding NAND string 506. The source of each source select gate 510 is connected to a common source line 518. A control gate 520 of each source select gate 510 is connected to the source select line 514.

In one embodiment, the common source line 518 is connected between source select gates 510 for NAND strings 506 of two different NAND arrays. Thus, the two NAND arrays share the common source line 518.

In an embodiment, the drain of each drain select gate 512 may be connected to the bit line 504 of the corresponding NAND string 506 at a drain contact 522. The source of each drain select gate 512 is connected to the drain of the last charge trapping memory cell 508 of the corresponding NAND string 506. In one embodiment, at least two NAND strings 506 share the same drain contact 522.

In accordance with the described embodiments, each memory cell 508 may include a source 524 (e.g., a first source/drain region), a drain 526 (e.g., a second source/drain region), a charge storage region 528 (e.g., a floating gate stack or a dielectric layer stack) and a control gate 530 (e.g. a gate region). The control gate 530 of each memory cell 508 may be connected to a respective word line 502. A column of the NAND memory cell array portion 500 may include a respective NAND string 506 and a row of the NAND memory cell array portion 500 may include those memory cells 508 that are commonly connected to a respective word line 502.

In an alternative embodiment, the memory cell portion 500 is a NOR memory cell array portion 500. In yet another embodiment, the memory cell portion 500 may be arranged in accordance with any other suitable architecture.

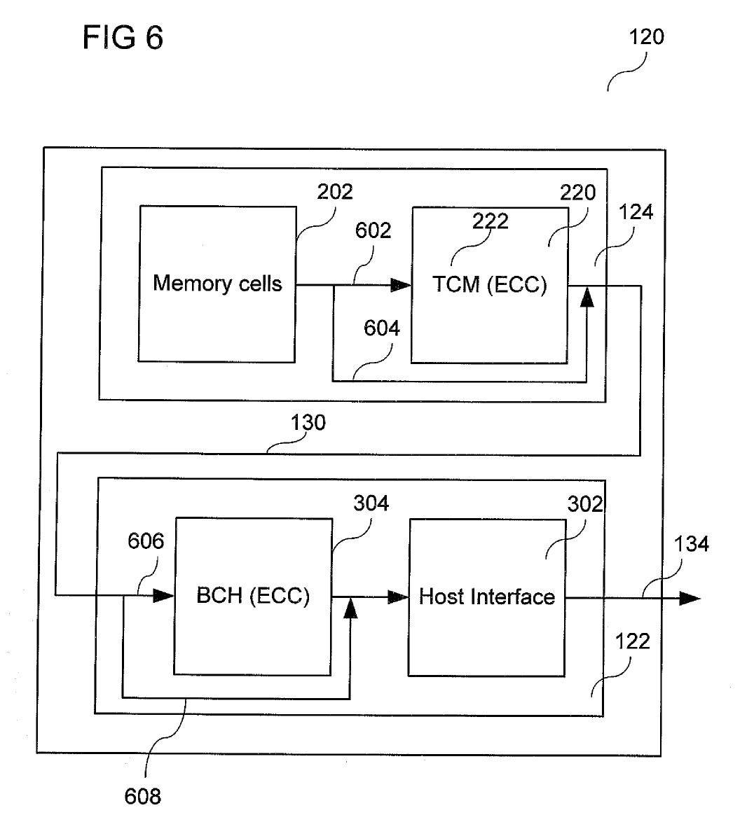

FIG. 6 shows a portion of an example of the memory cell arrangement 120 in accordance with an embodiment illustrating a data flow during a read operation for reading data from memory cells of the memory cell field 202 of the memory 124. For illustrative purposes, only some of the components involved in a read operation are shown in FIG. 6.

As shown in FIG. 6, an output of the memory cell field 202 may be coupled with an input of the memory-internal controller 220 (which may be implemented as an ARM controller, for example), which may include a Tightly Coupled Memory (TCM) circuit (e.g. a memory which resides directly on a processor, e.g., the memory-internal controller 220). In an example, the output of the memory cell field 202 may be coupled with an input of a memory-internal error detection circuit and/or a memory-internal error correction circuit 222, e.g., a parity-check error detection circuit and/or a parity-check error correction circuit.

The coupling may be provided, e.g., via a first read path 602, which may start from the output of the memory cell field 202 and may extend to the input of the memory-internal error detection circuit and/or the memory-internal error correction circuit 222. An output of the memory-internal error detection circuit and/or the memory-internal error correction circuit 222 may be coupled with an output of the memory 124. Thus, in an example, raw data read from the memory cells are provided at the output of the memory cell field 202 and first error corrected data (e.g., raw data being error corrected using the memory-internal error detection circuit and/or the memory-internal error correction circuit 222) may be provided at the output of the memory-internal error detection circuit and/or the memory-internal error correction circuit 222.

Furthermore, a second read path 604 may be provided in the memory 124. The second read path 604 may start from the output of the memory cell field 202 and may extend to the output of the memory 124, bypassing the memory-internal error detection circuit and/or the memory-internal error correction circuit 222. Thus, the data being transferred via the second read path 604 might not pass the memory-internal error detection circuit and/or the memory-internal error correction circuit 222 and thus would not be processed by the memory-internal error detection circuit and/or the memory-internal error correction circuit 222. This may save a substantial amount of processing time. Thus, in an example, data being transferred via the second read path 604 may be available at the output of the memory 124 earlier than the data being transferred via the first read path 602, which would be processed by the memory-internal error detection circuit and/or the memory-internal error correction circuit 222 (illustratively, the processing time for carrying out the error detection and/or error correction operation on the read data would be saved). The option of bypassing the memory-internal error detection circuit and/or the memory-internal error correction circuit 222 when reading data from the memory cell field 202 may be used in an embodiment in order to shorten the read latency, in other words the time required for carrying out a read operation, as will be described in more detail below.

An output of the memory-internal error detection circuit and/or the memory-internal error correction circuit 222 may be coupled with an input of the one or more error detection circuits and/or one or more error correction circuits 304 of the memory cell arrangement controller 122, wherein the one or more error detection circuits and/or one or more error correction circuits 304 may be configured to detect/correct errors using, e.g., a Bose, Ray-Chaudhuri (BCH) error detection/correction scheme. The coupling of the output of the memory-internal error detection circuit and/or the memory-internal error correction circuit 222 with the input of the one or more error detection circuits and/or one or more error correction circuits 304 of the memory cell arrangement controller 122 may be provided e.g. via a third read path 606, which may start from the output of the memory-internal error detection circuit and/or the memory-internal error correction circuit 222 and may extend to the one or more error detection circuits and/or one or more error correction circuits 304 of the memory cell arrangement controller 122. An output of the one or more error detection circuits and/or one or more error correction circuits 304 of the memory cell arrangement controller 122 may be coupled with an input of the host interface circuit 302.

Furthermore, a fourth read path 608 may be provided in the memory cell arrangement controller 122. The fourth read path 608 may start from the output of the memory-internal error detection circuit and/or the memory-internal error correction circuit 222 and may extend to the input of the host interface circuit 302, bypassing the one or more error detection circuits and/or one or more error correction circuits 304 of the memory cell arrangement controller 122.

Thus, the data being transferred via the fourth read path 608 might not pass the one or more error detection circuits and/or one or more error correction circuits 304 and thus would not be processed by the one or more error detection circuits and/or one or more error correction circuits 304. This may save a substantial amount of processing time. Thus, in an example, data being transferred via the fourth read path 608 may be available at the input of the host interface circuit 302 earlier than the data being transferred via the third read path 606, which would be processed by the one or more error detection circuits and/or one or more error correction circuits 304 (illustratively, the processing time for carrying out the error detection and/or error correction operation on the read data in the one or more error detection circuits and/or one or more error correction circuits 304 would be saved). The option of bypassing the one or more error detection circuits and/or one or more error correction circuits 304 when reading data from the memory cell field 202 may be used in an embodiment in order to even further shorten the read latency, in other words the time required for carrying out a read operation, as will be described in more detail below.

Thus, in an example, depending on whether the first read path 602 or the second read path 604 is selected, raw data read from the memory cells or first error corrected data may be provided at the output of the memory 124 and may be supplied to the input of the one or more error detection circuits and/or one or more error correction circuits 304 of the memory cell arrangement controller 122 or to the input of the host interface circuit 302.

It is to be noted that in an example, the four read paths can be arbitrarily selected independent from each other and in any meaningful combination (e.g., it may be selected to use the first read path 602 and the third read path 606, or the first read path 602 and the fourth read path 608, or the second read path 604 and the third read path 606, or the second read path 604 and the fourth read path 608, for example, as desired). Various parameters which may be used for deciding which read paths should be selected will be described further below. One example of a parameter that could be used is an expected failure rate of the memory cells of the memory cell arrangement 120.

As will be described in more detail below, in an implementation, the memory cell arrangement controller 122 may be configured to enable or disable the respective read paths 602, 604, 606, 608. In other words, the memory cell arrangement controller 122 may be configured to enable or disable, e.g., the TCM bypass path (e.g., the second read path 604) and/or the BCH bypass path (e.g., the fourth read path 608), e.g., as needed or desired according to, e.g., the expected failure rate of the memory cells of the memory cell arrangement 120.

In an example, even if one or more bypass paths are enabled, the respectively bypassed error detection/error correction circuit (e.g., 222, 304) may be used for error detection. In this example, it may be provided that in case that the respective error detection/error correction circuit (e.g., 222, 304) used for error detection detects an error in the supplied read data, the data which may already have bypassed the respective error detection/error correction circuit (e.g., 222, 304) and supplied to the next component in the memory cell arrangement 120 (e.g., the one or more error detection circuits and/or one or more error correction circuits 304 or the host interface circuit 302) may be castaway. An error correction may be provided in this case on the erroneous data and the error corrected read data may be re-sent or provided to the respective component in the memory cell arrangement 120 (e.g., the one or more error detection circuits and/or one or more error correction circuits 304 or the host interface circuit 302).

In an embodiment, it has been realized that the fail probability of the memory cells of a memory cell arrangement is usually low or zero at the beginning of its life-time (e.g., in case of a non-volatile memory cell arrangement) and typically increases with the cycling of the device, in other words with the number of access operations (e.g., read or write operations) performed on the memory cells of a memory cell arrangement. Taking into account that the fail probability may be highly dependent on the life-time history of the memory cells of a memory cell arrangement, in an implementation, the latency can be reduced in early lifetime by means of bypassing one or more of usually provided error detection circuits and/or one or more error correction circuits (ECC).

Referring back to the example shown in FIG. 3, the selection of the read paths as described with reference to FIG. 6 would be implemented by individually enabling and disabling the one or more error detection circuits and/or one or more error correction circuits (ECC) (e.g., 304).

As will be described in more detail below, a step-wise addition of error detection and/or error correction capability may be provided in an implementation according to one or more predefined criteria. By way of example, one or more error detection circuits and/or error correction circuits may be step-wise additionally enabled in accordance with one or more predefined criteria.

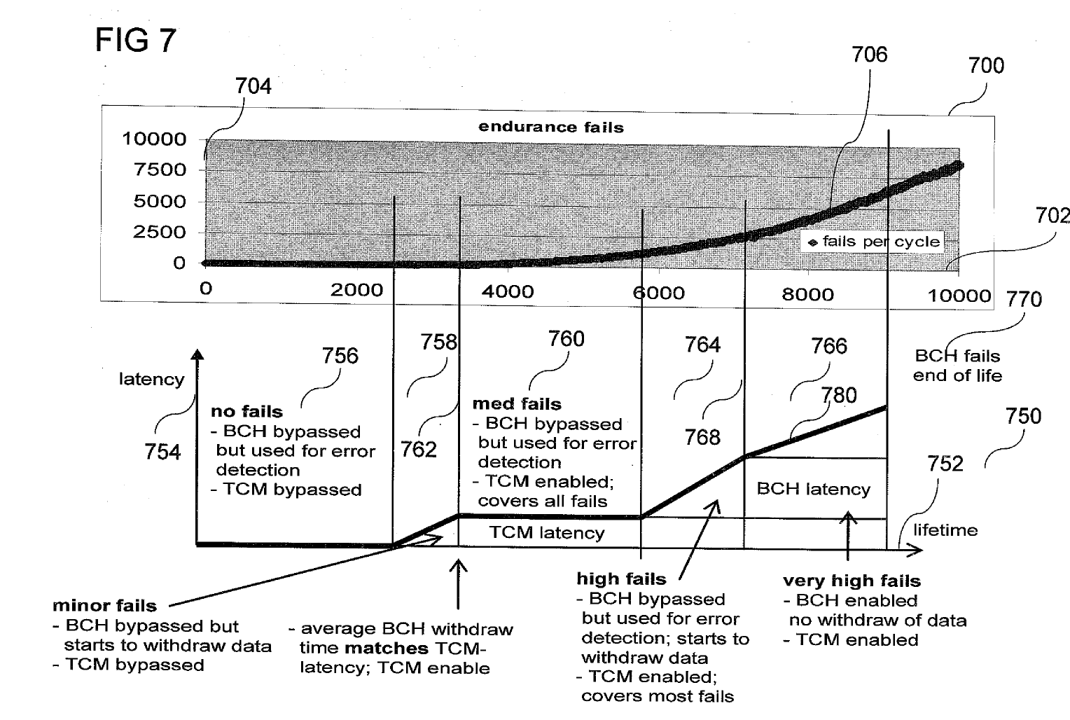

FIG. 7 shows an endurance failure diagram 700 and a corresponding latency diagram 750 in accordance with an embodiment to illustrate an exemplary implementation.

The endurance failure diagram 700 includes a cycle axis 702 showing a number of (write and/or erase and/or read) cycles carried out on the memory cells of a memory cell arrangement, and a failure axis 704 showing the number of failures in the memory cells of a memory cell arrangement. Furthermore, the endurance failure diagram 700 includes a characteristic 706 which illustrates that in an example, the number of failing memory cells increases with the number of (write and/or erase and/or read) cycles carried out on the memory cells of the memory cell arrangement. It is to be understood that the characteristic 706 is only exemplary and may vary dependent on the type of memory cells and the architecture of the memory, for example.

Referring also to the latency diagram 750 in FIG. 7 (which may include a lifetime axis 752 showing the lifetime of the memory cell arrangement in units of cycles, for example, and a latency axis 754, which illustrates the latency of data which are read from the memory cell field 202, for example, when they are transferred through the components of the memory cell arrangement 120 until they are provided at the output of the memory cell arrangement 120, for example), in a first lifetime interval 756 (e.g., extending from the beginning of the usage of the memory cell arrangement to about a few thousand cycles, e.g., to about 2500 cycles), no or only a negligible amount of failures (errors) in the memory cells may be detected or occur. In the first lifetime interval 756, in an example, it may be decided not to use any error correction circuits at all and may therefore bypass the error correction circuits of the memory cell arrangement. In an example, the second read path 604 and the fourth read path 608 may be selected for the data flow of the data read from the memory cells in the first lifetime interval 756. However, the error detection functionality of one or more error detection circuits may be used in parallel to monitor as to whether any errors in the read data occur. Thus, in an example, in the first lifetime interval 756, the memory cell arrangement may be operated in a first operating mode, in which the data read from the memory cells are directly supplied to the host interface circuit 302, bypassing the memory-internal error detection circuit and/or a memory-internal error correction circuit 222, and the one or more error detection circuits and/or one or more error correction circuits 304, but still simultaneously monitoring the data for any errors using the memory-internal error detection circuit and/or the memory-internal error correction circuit 222, and/or the one or more error detection circuits and/or one or more error correction circuits 304. In an example, the most powerful error detection circuit (e.g., the one or more error detection circuits 304) may be used for error detection and the less powerful (in the sense of error detection capability) error detection circuits (e.g., the memory-internal error detection circuit 222) may be bypassed.

Furthermore, the latency diagram 750 of FIG. 7 further shows a second lifetime interval 758 (e.g., extending from about a few thousand cycles, e.g. from about 2500 cycles, to about 3500 cycles), a minor amount (but no longer negligible amount) of failures occur and would be detected (e.g., using the one or more error detection circuits). In this second lifetime interval 758, e.g., the one or more error detection circuits 304 start to detect errors in the read data. In case of a detected error, the data that are bypassing the one or more error correction circuits 304 might be withdrawn from the memory interface circuit 308 and would not be supplied uncorrected to the output of the memory cell arrangement. In this case, the erroneous data are supplied to the one or more error correction circuits 304 (e.g., using BCH error correction) to be corrected, thereby providing error corrected data at the output of the one or more error detection circuits 304. The error corrected data would then be supplied to the memory interface circuit 308 for being output by the memory cell arrangement. This would lead to a significant delay of the data read in this single case, but since the number of withdrawals of raw data read from the memory cells from the memory interface circuit 308 is still low, the total latency might still be significantly shorter compared with the case, in which the one or more error correction circuits 304 are always used for error correction of the raw data in the second lifetime interval 758. Thus, in an example, in the second lifetime interval 758, the memory cell arrangement may be operated in a second operating mode, in which the data read from the memory cells are directly supplied to the memory interface circuit 308, bypassing the memory-internal internal error detection circuit and/or a memory-internal error correction circuit 222, and the one or more error detection circuits and/or one or more error correction circuits 304, but may be withdrawn and replaced by first error corrected data. As shown in FIG. 7, the latency increases with the number of errors in the data that might occur due to the increasing cycle numbers.

As shown in FIG. 7, in a third lifetime interval 760 (e.g., extending from about 3500 cycles to about 5800 cycles in this example), the latency that is added due to withdrawal of the raw data from the memory interface circuit 308 first matches the latency (at a first switching time 762) which would occur when all raw data would be error corrected using the fastest error correction circuit (e.g., having the least error correction capability, e.g., the one or more memory-internal error correction circuits 222) and then would even exceed it. Therefore, in an example, all the raw data read from the memory cells are supplied to the memory-internal error correction circuit 222 (e.g., the first read path 602 is selected), which is used for error correcting the raw data using, e.g., a parity check error correction. Furthermore, in the third lifetime interval 760 the one or more error detection circuits and/or one or more error correction circuits 304 are still bypassed (e.g., the fourth read path 608 is selected). However, the error detection function of the one or more error detection circuits 304 is already used for additional error detection of the first corrected data provided by the one or more memory-internal error correction circuits 222. In this example, the error detection capability of the one or more error detection circuits 304 is more powerful (more errors can be detected) than the error detection capability of the one or more memory-internal error detection circuits 222. Thus, the latency characteristics 780 in the latency diagram 750 of FIG. 7 shows in the third lifetime interval 760 a constant latency (e.g., a TCM latency) which represents the processing time of the one or more memory-internal error correction circuits 222. In the third lifetime interval 760, it is assumed that the one or more memory-internal error correction circuits 222 are able to cover all fails (all errors) in the data read from the memory cells. Thus, in an example, in the third lifetime interval 762, the memory cell arrangement may be operated in a third operating mode, in which the data read from the memory cells are supplied to the one or more memory-internal error correction circuits 222 for a first error correction, and the first corrected data are directly supplied to the memory interface circuit 308, bypassing the one or more error detection circuits and/or one or more error correction circuits 304, but may be withdrawn and replaced by the first error corrected data.

With an increasing number of cycles, the number of failures might further increase. In this example, it is assumed for illustrative purposes, that in a fourth lifetime interval 764 (e.g., extending from about 5800 cycles to about 7300 cycles in this example), the error correction capability of the one or more memory-internal error correction circuits 222 is no longer sufficient to cover all fails (in other words, even the first corrected data include errors, which could not have been corrected by the one or more memory-internal error correction circuits 222). However, it is assumed that in the fourth lifetime interval 764 the one or more memory-internal error correction circuits 222 are capable of correcting most of the errors that occur in the read data. Thus, in an example, in the fourth lifetime interval 764, the memory cell arrangement may still be operated in the third operating mode.

In this fourth lifetime interval 764, e.g., the one or more error detection circuits 304 start to again detect errors in the read data, this time in the first corrected data. In case of a detected error, the data that are bypassing the one or more error correction circuits 304 (in this case the first corrected data) might be withdrawn from the memory interface circuit 308 and would not be supplied uncorrected to the output of the memory cell arrangement. In this case, the erroneous data are supplied to the one or more error correction circuits 304 (e.g., using BCH error correction) to be corrected, thereby providing error corrected data at the output of the one or more error detection circuits 304. The error corrected data would then be supplied to the memory interface circuit 308 for being output by the memory cell arrangement. This would lead to a significant delay of the data read in this single case, but since the number of withdrawals of first corrected data read from the memory cells from the memory interface circuit 308 is still low, the total latency might still be significantly shorter compared with the case, in which the one or more error correction circuits 304 would always be used for error correction of the first corrected data in the fourth lifetime interval 764. As shown in FIG. 7, the latency increases with the number of errors in the data that might occur due to the increasing cycle numbers. However, the error detection function of the one or more error detection circuits 304 is already used for additional error detection of the first corrected data provided by the one or more memory-internal error correction circuits 222. In this example, the error detection capability of the one or more error detection circuits 304 is more powerful (more errors can be detected) than the error detection capability of the one or more memory-internal error detection circuits 222.

As shown in FIG. 7, in a fifth lifetime interval 766 (e.g., extending from about 7300 cycles to about 9000 cycles in this example), the latency that is added due to withdrawal of the first corrected data from the memory interface circuit 308 first matches the latency (at a second switching time 768) which would occur when all first corrected data would be error corrected using in addition an even more powerful error correction circuit (e.g., having a higher error correction capability than, e.g., the one or more memory-internal error correction circuits 222, e.g., one or more error correction circuits 304) and then would even exceed it. Therefore, in an example, all the first corrected data read from the memory cells and error corrected using, e.g., the memory-internal error correction circuit 222 may be supplied to the one or more error correction circuits 304 (e.g., the third read path 606 is selected), which is used for further error correcting the first corrected data using, e.g., a BCH error correction or another powerful error correction. Illustratively, in the fifth lifetime interval 766, none of the error correction circuits 222, 304 is bypassed.

It should be noted that in case a higher number of error correction circuits with possibly increasing error correction capability than two would be provided, a step-wise addition of error correction power and thereby a step-wise increase of latency might be provided.

After an even higher number of cycles, the situation may occur, in which the number of errors becomes so high that it can no longer be corrected even when using all the error correction circuits provided in the memory cell arrangement. This would result in the end of life of the memory cell arrangement, in FIG. 7 indicated by reference number 770.

In various embodiments, a very low latency in the beginning of the lifetime of a memory cell arrangement may be achieved.

In another example, it may be provided that even after an enabling of one or more error correction circuits, one or more of the enabled error correction circuits may be individually disabled in case that it is determined that the respective enabled error correction circuit is currently not needed. Thus, in an example, an arbitrary individual enabling and disabling of the error correction circuits in the memory cell arrangement may be provided.

In an embodiment, it may be provided to bypass one or more ECC circuits, but still using the one or more bypassed ECC circuits in parallel for error detection (e.g. for cyclic redundancy check, CRC) and withdraw fail affected data (e.g., before they are output by the memory cell arrangement).

In an embodiment, a plurality (e.g., more than three) error correction circuits may be provided and may be coupled with each other in series (illustratively, they may be chained). In this case, individually selected error correction circuit(s) may be bypassed, e.g., in the manner as described above.

Furthermore, a parallel execution of data streaming at the host interface (e.g., the memory interface 308) and ECC computation (e.g., for error detection) may be provided in various embodiments.

In an implementation, a circuit (e.g., a switch or a controller) may be additionally provided (e.g., near the host interface), which may be configured to interrupt the data stream, e.g., in case a ECC computation indicates errors and thus results in the detection of an error in the data stream read from the memory cells.

A variety of different parameters may be used in order to determine as to whether one or more of the error correction circuits should be enabled or disabled. In an example, a fail-probability of the memory cells in the memory cell arrangement (in other words, in the memory system) may be determined, e.g., measured.

In case the fail-probability of the memory cells in the memory cell arrangement is low (e.g., below a predefined fail-probability threshold), one or more enabled error correction circuits may be disabled (e.g., individually disabled). Alternatively or in addition, one or more error correction circuits may be bypassed (which would result in a low latency) and the bypassed one or more error correction circuits may be used for error detection. In case an error is detected, data that is bypassed by the respective one or more error correction circuits may be withdrawn and the data may be error corrected using the previously bypassed one or more error correction circuits. The error corrected data may then replace the withdrawn data.

In case the fail-probability (or fail-rate) of the memory cells in the memory cell arrangement becomes so high that it increases above a specified level (by way of example, in case the fail-probability exceeds the predefined fail-probability threshold), the selected bypass read paths may be disabled and/or one or more previously bypassed or disabled error correction circuits may be enabled (or re-enabled).

Illustratively, in various embodiments, the determined fail-rate (alternatively or in addition history information about the usage and/or characteristics of the memory cell arrangement) may be taken into account in deciding as to whether, and if so, which error correction circuit(s) should be enabled or disabled.

In an embodiment, a dynamic bypass of ECC circuits for latency reduction may be provided (e.g. inside the memory cell arrangement controller and/or inside memory device itself). One or more bypassed ECC circuits may be used in parallel for error detection.

Furthermore, in an example, the fail-rate may be memory sector dependent within the memory. In this case, the fail-probability may be stored in the memory cell arrangement, e.g., in the memory and/or in the memory cell arrangement controller, to dynamically decide which bypass-mode to use, in other words, which ECC circuits should be disabled and which ECC circuits should be enabled.

Illustratively, multiple ECC-Units (ECC circuits) coupled in series may be used to reduce latency.

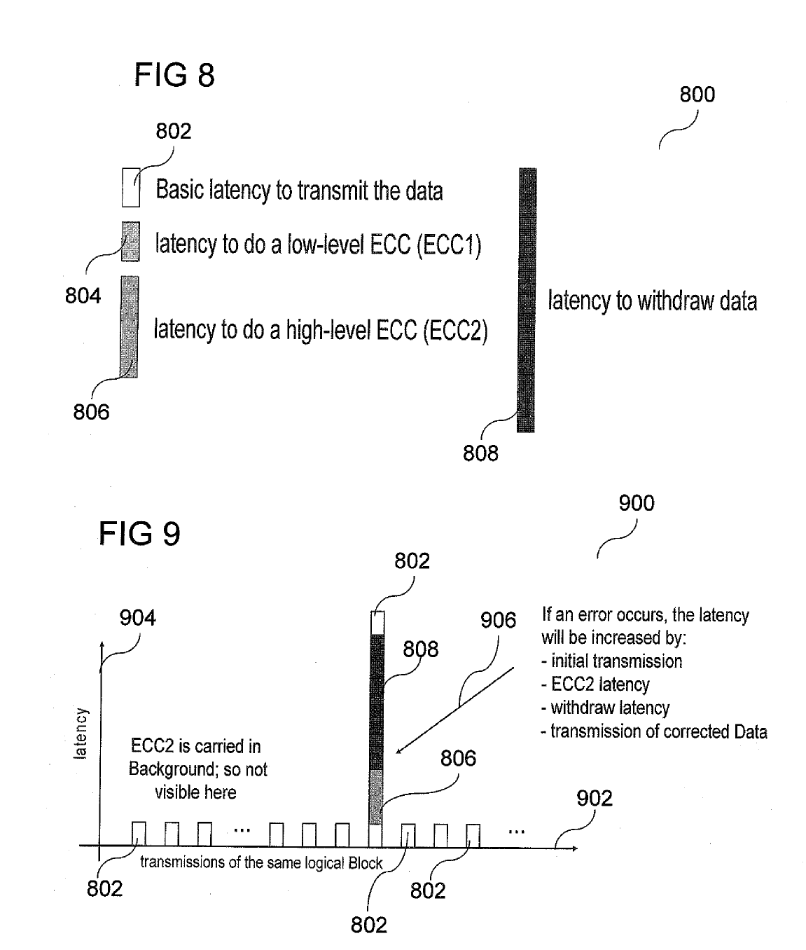

FIG. 8 shows an overview representation 800 of various latency representations in accordance with an embodiment. In this example, a basic latency (in other words a time interval) provided for transmitting data (e.g., for transmitting a read memory block) within the memory cell arrangement (without any error detection or error correction processing time) is denoted with reference number 802. Furthermore, a latency (in other words a time interval) provided for carrying out a low-level error correction (e.g., the time provided for carrying out the error correction in the memory-internal error correction circuit 222) is denoted with reference number 804. A latency (in other words a time interval) provided for carrying out a high-level error correction (e.g., the time provided for carrying out the error correction in the one or more error correction circuits 304) is denoted with reference number 806. Moreover, a latency (in other words a time interval) provided for a withdrawal of data from being output by the memory cell arrangement is denoted with reference number 808. The reference numbers as well as the respective hatchings assigned to the respective blocks will be used throughout the following figures for the purpose of an easier understanding.

As will be described in more detail below, various embodiments achieve a reduction of the average latency e.g. over the entire lifetime of a memory cell arrangement. In the examples, it is assumed that the data stored in the memory cells are error protected using redundancy information that has been generated in accordance with all provided error correction circuits. By way of example, in case n (n is an arbitrary integer value greater than 0) error correction schemes (ECCs) are provided which may be independent from each other and which may be configured such that they do not interfere with each other, the stored data is encoded in accordance with the provided ECC (e.g. all the data is encoded and stored in accordance with ECC1, ECC2, ECC3, . . . , ECCn). Furthermore, it is assumed that before reading a piece of data (e.g., a memory block), it is known which ECC should be chosen in order to achieve optimized latency. It is to be noted that this can be different for different pieces of data. Furthermore, this can even change over the lifetime of the memory cell arrangement.

FIG. 9 shows a first latency diagram 900 in accordance with an embodiment. The first first latency diagram 900 may include a lifetime axis 902 showing the lifetime of the memory cell arrangement in units of cycles, for example, and a latency 904, which illustrates the latency of data which are read from the memory cell field 202, for example, when they are transferred through the components of the memory cell arrangement 120 until they are provided at the output of the memory cell arrangement 120, for example. As shown in FIG. 9, in this example, in the beginning of the lifetime of the memory cell arrangement, the error probability is very low and all data read from the memory cells are transmitted immediately to the output of the memory cell arrangement, bypassing, e.g., all available error correction circuits, but the data may be checked in the background using one or more of the error correction circuits, if the data are correct. In this example, a second ECC2 is carried out in the background in order to detect possible errors in the read data. If an error occurs (which is symbolized in FIG. 9 by an arrow 906), the bypassed data are withdrawn (with high time costs) and transmitted again without error.

As shown in FIG. 9, in each case when the bypassed data are withdrawn, the latency for this single transmission of the read data might be increased by:
the latency 806 provided for carrying out a high-level error correction;
the latency 808 provided for the withdrawal of the data from being output by the memory cell arrangement; and
the basic latency 802 provided for transmitting data within the memory cell arrangement for the additional transmission of the data.

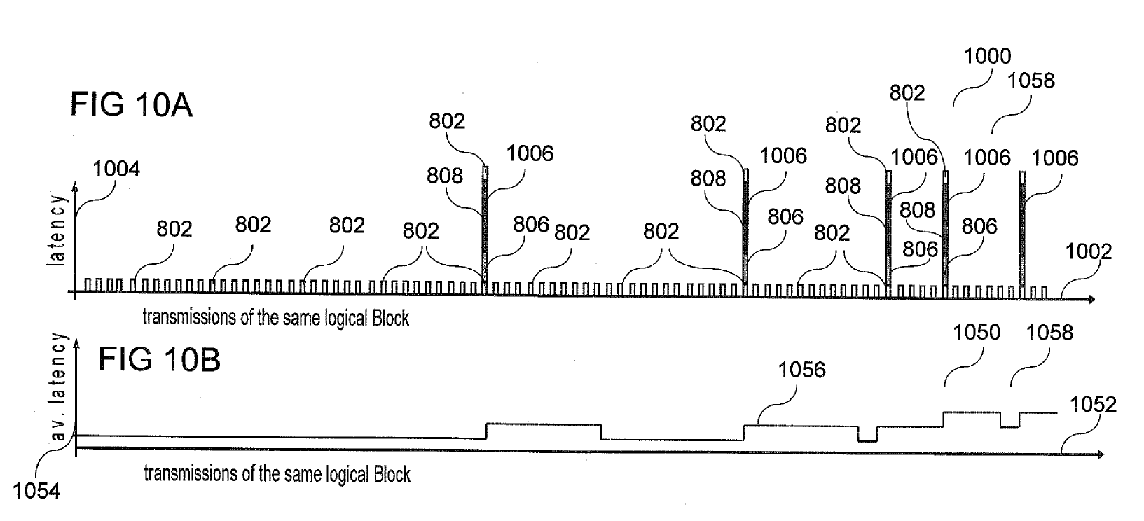

FIGS. 10A and 10B show a second latency diagram 1000 (FIG. 10A) and an assigned average latency diagram 1050 (FIG. 10B) in accordance with an embodiment. The second latency diagram 1000 may include a lifetime axis 1002 showing the lifetime of the memory cell arrangement in units of cycles, for example, and a latency 1004, which illustrates the latency of data which are read from the memory cell field 202, for example, when they are transferred through the components of the memory cell arrangement 120 until they are provided at the output of the memory cell arrangement 120, for example. The assigned average latency diagram 1050 may include a lifetime axis 1052 showing the lifetime of the memory cell arrangement in units of cycles, for example, and an average latency 1054, which illustrates the average latency of data (referring to the second latency diagram 1000) which are read from the memory cell field 202, for example.

As shown in FIGS. 10A and 10B, each time an error occurs (a detected error is denoted in FIG. 10A using the reference number 1006), the additional latency as described with reference to FIG. 9 will occur, which will lead to an increase also of the average latency (see average latency characteristic 1056 in FIG. 10B). However, in case an error only rarely occurs, the average latency will decrease again. But the more frequent an error occurs, the more the average latency will increase (as shown in the end portion 1058 of the second latency diagram 1000 and the average latency characteristic 1056). Thus, illustratively, in an example, the average latency will increase over time.

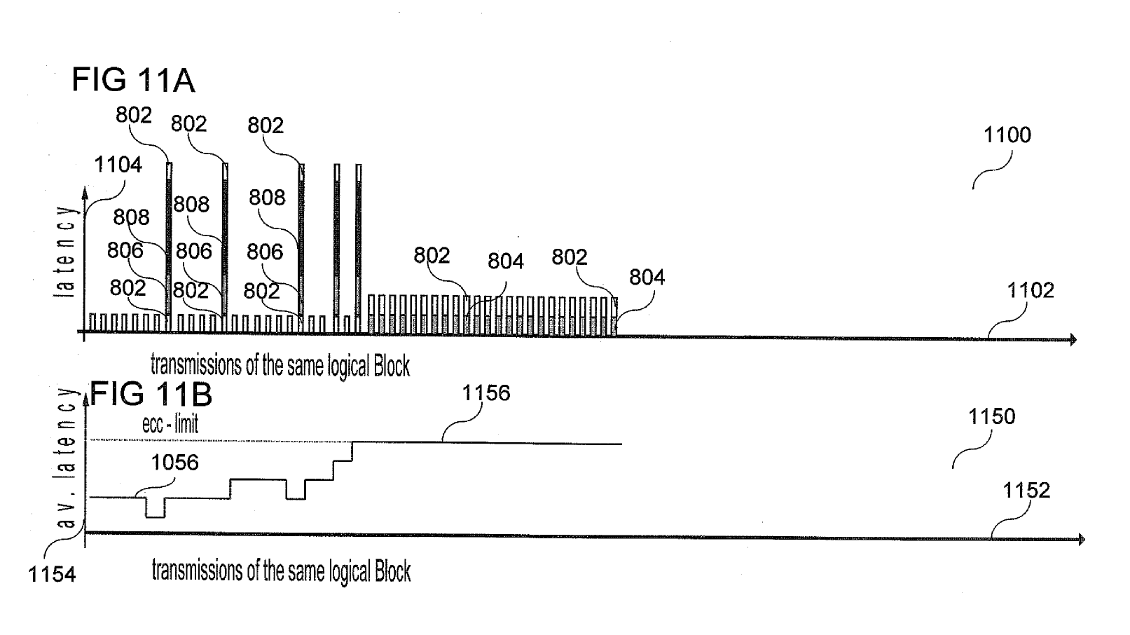

FIGS. 11A and 11B show a third latency diagram 1100 (FIG. 11A) and an assigned average latency diagram 1150 (FIG. 11B) in accordance with an embodiment. The third latency diagram 1100 may include a lifetime axis 1102 showing the lifetime of the memory cell arrangement in units of cycles, for example, and a latency 1104, which illustrates the latency of data which are read from the memory cell field 202, for example, when they are transferred through the components of the memory cell arrangement 120 until they are provided at the output of the memory cell arrangement 120, for example. The assigned average latency diagram 1150 may include a lifetime axis 1152 showing the lifetime of the memory cell arrangement in units of cycles, for example, and an average latency 1154, which illustrates the average latency of data (referring to the third latency diagram 1100) being read from the memory cell field 202, for example. In this example, it is determined, as to whether the average latency for the memory cell arrangement reaches or exceeds a certain limit, e.g., a predefined latency threshold 1156. If the average latency reaches or exceeds the limit 1156, a first error correction (e.g., ECC1) may be enabled and may be used to correct all data. This is also shown in FIG. 11A, where the additional latency 804 provided for carrying out a low-level error correction is shown for each read data block after the first error correction has been enabled. Furthermore, in this example, it is assumed that at this stage, the low-level error correction is able to correct all errors. Therefore, no additional error events occur in the error corrected data as shown in FIG. 11A.

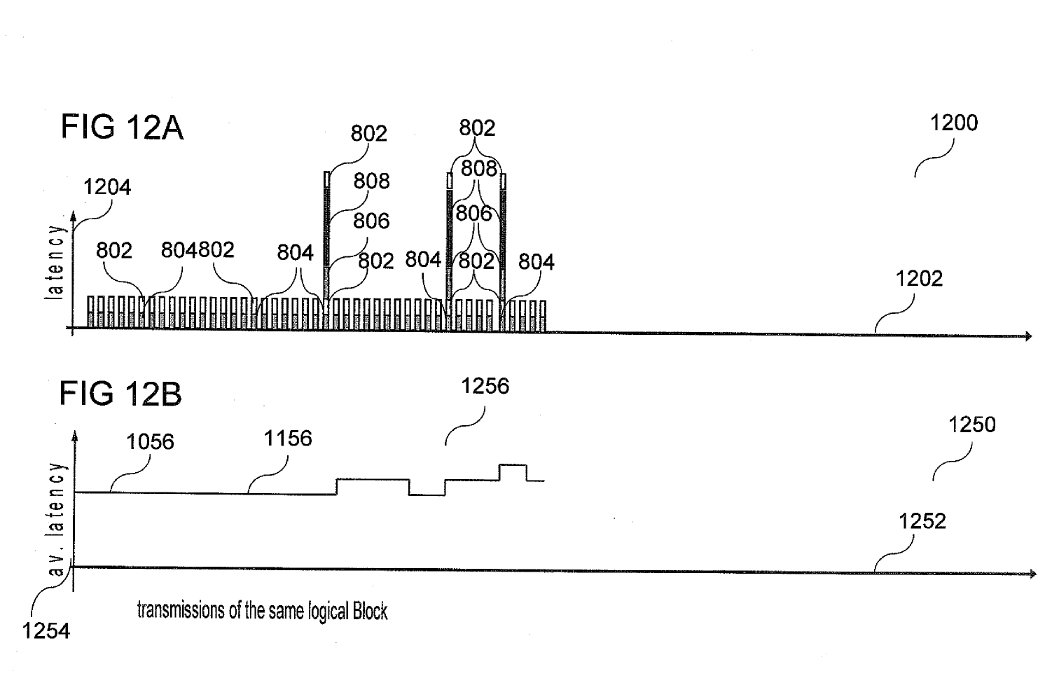

FIGS. 12A and 12B show a fourth latency diagram 1200 (FIG. 12A) and an assigned average latency diagram 1250 (FIG. 12B) in accordance with an embodiment. The fourth latency diagram 1200 may include a lifetime axis 1202 showing the lifetime of the memory cell arrangement in units of cycles, for example, and a latency 1204, which illustrates the latency of data which are read from the memory cell field 202, for example, when they are transferred through the components of the memory cell arrangement 120 until they are provided at the output of the memory cell arrangement 120, for example. The assigned average latency diagram 1250 may include a lifetime axis 1252 showing the lifetime of the memory cell arrangement in units of cycles, for example, and an average latency 1254, which illustrates the average latency of data (referring to the fourth latency diagram 1200) being read from the memory cell field 202, for example. In this example, as shown in FIG. 12 A, after having enabled the ECC1, most of the errors could be corrected and the number of errors is reduced again. Over the time, the number of errors which could not be corrected by the first error correction circuit ECC1 increases. In this example, the second ECC2 is still carried out in the background in order to detect possible errors in the data which are now already corrected (as far as possible) by the first error correction circuit ECC1. If an error occurs, the bypassed data are withdrawn (with high time costs) and transmitted again without error. In this example, it is assumed that again after a certain number of data transfers (cycles), some data must be withdrawn as ECC1 failed to correct the data. This increases the average latency above the limit, e.g., the predefined latency threshold 1156 (see end portion 1256 of the portion of the average latency characteristic 1056 in FIG. 12B).

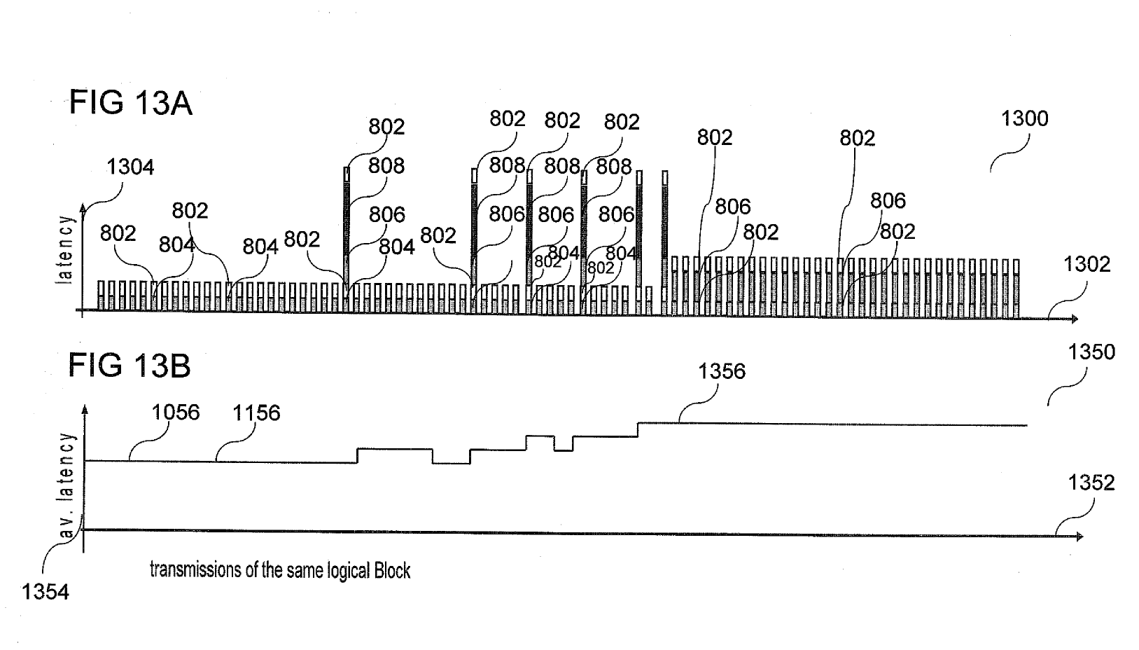

FIGS. 13A and 13B show a fifth latency diagram 1300 (FIG. 13A) and an assigned average latency diagram 1350 (FIG. 13B) in accordance with an embodiment. The fifth latency diagram 1300 may include a lifetime axis 1302 showing the lifetime of the memory cell arrangement in units of cycles, for example, and a latency axis 1304, which illustrates the latency of data which are read from the memory cell field 202, for example, when they are transferred through the components of the memory cell arrangement 120 until they are provided at the output of the memory cell arrangement 120, for example. The assigned average latency diagram 1350 may include a lifetime axis 1352 showing the lifetime of the memory cell arrangement in units of cycles, for example, and an average latency 1354, which illustrates the average latency of data (referring to the third latency diagram 1300) being read from the memory cell field 202, for example. In this example, it is determined, as to whether the average latency for the memory cell arrangement reaches or exceeds a certain second limit, e.g., a predefined second latency threshold 1356. If the average latency reaches or exceeds the second limit 1356, a second error correction (e.g., ECC2) may be enabled (instead or in addition to the first error correction) and may be used to correct all data. This is also shown in FIG. 13A, where the additional latency 806 provided for carrying out a high-level error correction is shown for each read data block after the second error correction has been enabled.

This described example could be extended to an arbitrary number of error corrections which could be individually enabled and disabled according to the determined average latency, for example.

In an example, the determination or calculation of the average latency may be implemented using a counter, for example. If data are withdrawn, a certain predefined value may be added to a current counter value of that counter. If no data are withdrawn, the counter value may be reduced (in an example not below the counter value zero). If the counter value reaches a certain predefined value (e.g., representing the certain limit as described above), the next ECC (e.g., ECC1 or ECC2) may be enabled.

By way of example, a counter value x may be provided to calculate the average latency. To withdraw data might cost, for example, 20 times more than the initial latency. In one example, the counter value x may be initialized with an initialization value (e.g., “0”). If data is withdrawn, e.g., the value “20” may be added to the counter value x. If the read data go through the memory cell arrangement without withdraw (i.e., no error has been detected for the read data), the counter value x may be reduced, e.g., by the value “1”. If the counter value x reaches or exceeds e.g. a limit value “120” (the larger the limit value, the larger the integration time), the next ECC (e.g., ECC1 or ECC2) may be enabled by default.

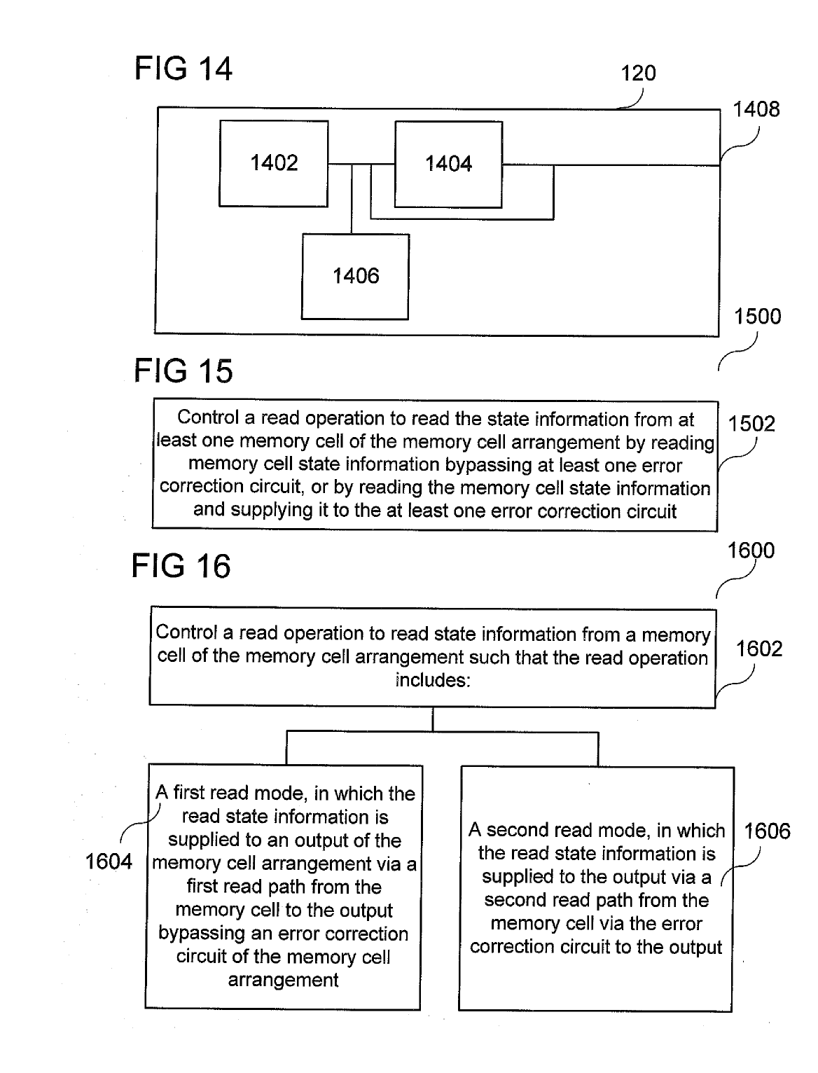

FIG. 14 shows another example of a memory cell arrangement 120 of FIG. 1. In this example, the memory cell arrangement 120 may include at least one memory cell 1402, at least one error correction circuit 1404, and a controller 1406. The controller 1406 may be configured to control a read operation to read state information from the at least one memory cell 1402 by reading a memory cell state information bypassing the at least one error correction circuit 1404 and optionally provide the memory cell state information at an output 1408, or by reading the memory cell state information and supplying it to the at least one error correction circuit 1404.

The at least one error correction circuit 1404 may include a plurality of error correction circuits. Furthermore, the plurality of error correction circuits may be coupled with each other in series.

In an example, at least one error detection circuit may be provided. The at least one error detection circuit may be configured to carry out error detection based on at least one error detection process selected from a group of error detection processes consisting of:
a parity-check error detection process, and/or
a Bose, Ray-Chaudhuri (BCH) error detection process, and/or
a Reed-Solomon error detection process, and/or
a cyclic redundancy check (CRC) error detection process, and/or
a convolutional codes error detection process.

The at least one error correction circuit may be implemented together with the at least one error detection circuit. The at least one error correction circuit may include a plurality of error correction circuits. The plurality of error correction circuits may be coupled with each other in series (e.g., forming an error correction circuit chain). In this example, an input of the first error correction circuit of the plurality of error correction circuits may be configured to receive the read memory cell state information, an input of the second error correction circuit of the plurality of error correction circuits may be configured to receive information representing the read memory cell state information, and the second error correction circuit may have a higher error correction capability than the first error correction circuit. Furthermore, in an example, the controller may be configured to control the second error correction circuit to carry out an error correction process on the information representing the read memory cell state information in case the first error correction circuit is unable to correct an error in the read memory cell state information.

In another example of this embodiment, the first error correction circuit may be configured to carry out error correction based on a parity-check error correction process, and the second error correction circuit is configured to carry out error correction based on a Bose, Ray-Chaudhuri (BCH) error correction process.

In another example of this embodiment, the at least one error correction circuit may be configured to carry out error correction based on at least one error correction process selected from a group of error correction processes consisting of:
a parity-check error correction process, and/or
a Bose, Ray-Chaudhuri error correction process, and/or
a Reed-Solomon error correction process, and/or
a cyclic redundancy check error correction process, and/or
convolutional codes error correction process.

Furthermore, the controller may be configured to determine as to whether to control the read operation to read state information from the at least one memory cell by reading the memory cell state information bypassing the at least one error correction circuit, or by reading the memory cell state information and supplying it to the at least one error correction circuit depending on an error detection signal provided by the at least one error detection circuit, wherein the error detection signal indicates as to whether the read state information comprises an error or not.

The at least one memory cell may include at least one non-volatile memory cell. Furthermore, the at least one memory cell may include at least one resistive memory cell. In an example of this embodiment, the at least one memory cell may include at least one Flash memory cell. In an example, the at least one memory cell may include at least one charge storing memory cell such as, e.g., at least one floating gate memory cell or at least one charge trapping memory cell. Furthermore, the at least one memory cell may include a plurality of memory cells, wherein the plurality of memory cells may be serially source-to-drain coupled with each other. In an example, the plurality of memory cells may be coupled with each other in accordance with a NAND coupling structure.

In another embodiment, an integrated circuit having a memory cell arrangement is provided. The memory cell arrangement may include a memory cell, an error correction circuit, an output coupled to the memory cell and to the output, a first read path from the memory cell to the output bypassing the error correction circuit, a second read path from the memory cell via the error correction circuit to the output, and a controller configured to control a read operation to read state information from the memory cell such that the read operation may include a first read mode, in which the read state information is supplied to the output via the first read path, and a second read mode, in which the read state information is supplied to the output via the second read path.

In an example of this embodiment, the at least one error detection circuit may include at least one further error correction circuit. Furthermore, in an example, the integrated circuit may further include a third read path from the memory cell to the output bypassing the further error correction circuit, and a fourth read path from the memory cell via the further error correction circuit to the output. The fourth read path may include the second read path.

In an example of this embodiment, the error correction circuit and the further error correction circuit may be coupled with each other in series.

In an example of this embodiment, at least one error correction circuit may be provided. The at least one error detection circuit may be configured to carry out error detection based on at least one error detection process selected from a group of error detection processes consisting of:
a parity-check error detection process, and/or
a Bose, Ray-Chaudhuri error detection process, and/or
a Reed-Solomon error detection process, and/or
a cyclic redundancy check error detection process, and/or
a convolutional codes error detection process.

The at least one error correction circuit may include at least one further error correction circuit. Furthermore, the error correction circuit and the at least one further error correction circuit may be coupled with each other in series. In another example of this embodiment, an input of a first error correction circuit of the plurality of error correction circuits may be configured to receive the read memory cell state information, an input of a second error correction circuit of the plurality of error correction circuits may be configured to receive information representing the read memory cell state information, and the second error correction circuit may have a higher error correction capability than the first error correction circuit.

In another example of this embodiment, the controller may be configured to control the second error correction circuit to carry out an error correction process on the information representing the read memory cell state information in case the first error correction circuit is unable to correct an error in the read memory cell state information.

The first error correction circuit may be configured to carry out error correction based on a parity-check error correction process, and the second error correction circuit may be configured to carry out error correction based on a Bose, Ray-Chaudhuri (BCH) error correction process.

In another example of this embodiment, the at least one error correction circuit may be configured to carry out error correction based on at least one error correction process selected from a group of error correction processes consisting of:
a parity-check error correction process, and/or
a Bose, Ray-Chaudhuri error correction process, and/or
a Reed-Solomon error correction process, and/or
a cyclic redundancy check error correction process, and/or
a convolutional codes error correction process.

In an example, the controller may be configured to determine as to whether to control the read operation to read state information from the at least one memory cell by reading the memory cell state information bypassing the at least one error correction circuit, or by reading the memory cell state information and supplying it to the at least one error correction circuit depending on an error detection signal provided by the at least one error detection circuit, wherein the error detection signal indicates as to whether the read state information comprises an error or not.

In an example, the at least one memory cell may include at least one non-volatile memory cell. In another example, the at least one memory cell may include at least one resistive memory cell. Furthermore, the at least one memory cell may include at least one Flash memory cell. In another example, the at least one memory cell may include at least one charge storing memory cell such as, e.g., at least one floating gate memory cell or at least one charge trapping memory cell.

In another example, the at least one memory cell may include a plurality of memory cells, wherein the plurality of memory cells may be serially source-to-drain coupled with each other. The plurality of memory cells may be coupled with each other in accordance with a NAND coupling structure.

In another embodiment, an integrated circuit having a memory cell arrangement is provided. The memory cell arrangement may include an error detection circuit, an error correction circuit, and a controller. The controller may be configured to control a read operation to read state information from the at least one memory cell by reading, in a first read mode, a memory cell state information bypassing the error correction circuit, to determine, using the error detection circuit, as to whether the read memory cell state information fulfills a predefined criterion, and depending on whether the read memory cell state information fulfills the predefined criterion, to remain in the first read mode, or to switch to a second read mode, in which the memory cell state information is read and supplied to the error correction circuit for error correction.

In an example of this embodiment, the predefined criterion may be information about the number of programming cycles carried out on the memory cell arrangement or a part of the memory cell arrangement. The predefined criterion may be information about as to whether the error detection circuit detects an error in the read memory cell state information. In another example of this embodiment, the integrated circuit may further include a further error correction circuit. Furthermore, the controller may be further configured to determine, as to whether the read memory cell state information fulfills a further predefined criterion, and depending on whether the read memory cell state information fulfills the further predefined criterion, to remain in the first read mode or the second read mode, or to switch to a third read mode, in which the memory cell state information is read and supplied to the further error correction circuit for error correction.

In another example of this embodiment, the further predefined criterion may be information about the number of programming cycles carried out on the memory cell arrangement or a part of the memory cell arrangement. Furthermore, the further predefined criterion may be information about as to whether the error correction circuit is able to correct an error in the read memory cell state information.

In another example, the error detection circuit may be configured to carry out error detection based on at least one error detection process selected from a group of error detection processes consisting of:
a parity-check error detection process, and/or
a Bose, Ray-Chaudhuri error detection process, and/or
a Reed-Solomon error detection process, and/or
a cyclic redundancy check error detection process, and/or
a convolutional codes error detection process.

The further error correction circuit may have a higher error correction capability than the error correction circuit.

In another example, the error correction circuit may be configured to carry out error correction based on a parity-check error correction process, and the further error correction circuit may be configured to carry out error correction based on a Bose, Ray-Chaudhuri error correction process.

In yet another example, the error correction circuit may be configured to carry out error correction based on at least one error correction process selected from a group of error correction processes consisting of:
a parity-check error correction process, and/or
a Bose, Ray-Chaudhuri error correction process, and/or
a Reed-Solomon error correction process, and/or
a cyclic redundancy check error correction process, and/or
a convolutional codes error correction process.

The memory cell may include a non-volatile memory cell. In another example, the memory cell may include a resistive memory cell. Furthermore, the memory cell may include a Flash memory cell. Moreover, the memory cell may include a charge storing memory cell such as e.g. a floating gate memory cell or a charge trapping memory cell.

In an example, the integrated circuit may further include a plurality of memory cells, wherein the plurality of memory cells may be serially source-to-drain coupled with each other. In an example, the plurality of memory cells may be coupled with each other in accordance with a NAND coupling structure.

In another embodiment, as shown in FIG. 15, a method 1500 for reading a state information in a memory cell arrangement of an integrated circuit is provided. In accordance with this method, in 1502, a read operation is controlled to read the state information from at least one memory cell of the memory cell arrangement by reading memory cell state information bypassing at least one error correction circuit, or by reading the memory cell state information and supplying it to the at least one error correction circuit.

FIG. 16 shows a method 1600 for reading a state information in a memory cell arrangement of an integrated circuit in accordance with another embodiment. In accordance with this method, in 1602, a read operation is controlled to read state information from a memory cell of the memory cell arrangement such that the read operation may include, in 1604, a first read mode, in which the read state information is supplied to an output of the memory cell arrangement via a first read path from the memory cell to the output bypassing an error correction circuit of the memory cell arrangement, and, in 1606, a second read mode, in which the read state information is supplied to the output via a second read path from the memory cell via the error correction circuit to the output.

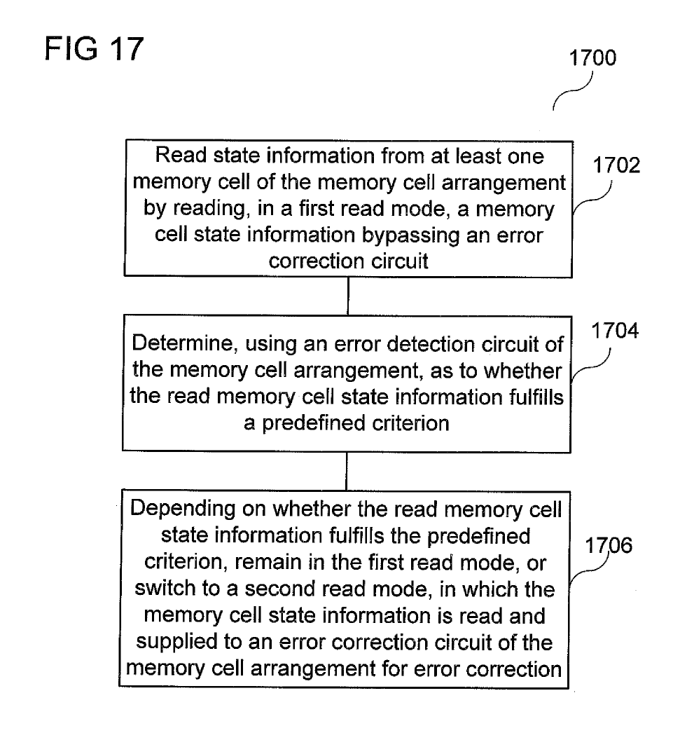

FIG. 17 shows a method 1700 for reading a state information in a memory cell arrangement of an integrated circuit in accordance with yet another embodiment. In 1702, state information is read from at least one memory cell of the memory cell arrangement by reading, in a first read mode, a memory cell state information bypassing the error correction circuit. Furthermore, in 1704, it is determined using an error detection circuit of the memory cell arrangement, as to whether the read memory cell state information fulfills a predefined criterion. Depending on whether the read memory cell state information fulfills the predefined criterion, the method further includes in 1706 remaining in the first read mode, or switching to a second read mode, in which the memory cell state information is read and supplied to an error correction circuit of the memory cell arrangement for error correction.

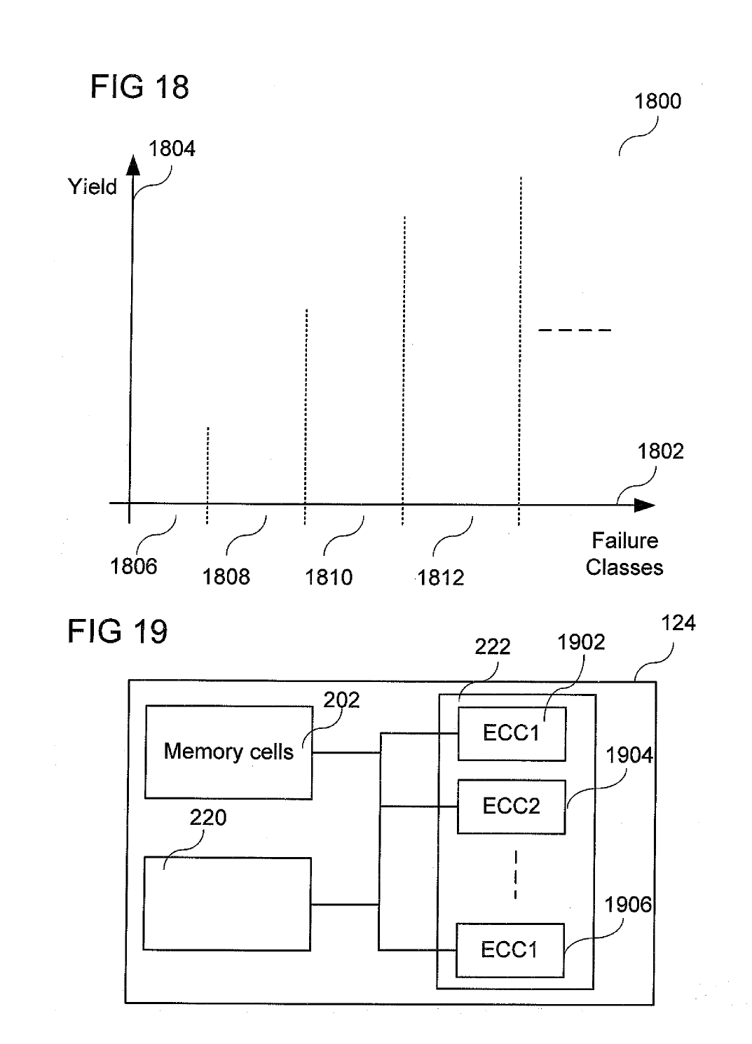

FIG. 18 shows a failure class diagram 1800 in accordance with an embodiment.

The failure class diagram 1800 may include a failure class axis 1802 illustrating different failure classes, which may be assigned to various error correction processes. Furthermore, the failure class diagram 1800 may include a yield axis 1804 illustrating a yield that is achieved for the respective memory cells. In an embodiment, each failure class may be assigned with one error correction process which would be provided for error correction in case the memory cell arrangement has been classified into this failure class. It should be noted that the classification of the memory cell arrangement into a respective failure class may change over the lifetime of the memory cell arrangement or for other reasons. In general, an arbitrary number of failure classes and assigned error correction processes may be provided. The error correction processes may have different error correction capabilities. In an example, the initial classification of the memory cell arrangement with respect to the failure class may be provided during the device test before shipping the device, in other words, the memory cell arrangement. In an embodiment, it may be provided that portions of the memory, (e.g. memory pages or memory sectors or memory blocks) may be individually classified into different failure classes. In this case, an error correction assignment table including the assignment of the respective portion of the memory to the respective error correction process (or failure class) may be provided for each classified portion. The classification of the memory cell arrangement may be carried out by determining error patterns and error distributions in a memory cell arrangement test process and then determining the suitable error correction process that will correct most of the occurring errors with least processing costs. Furthermore, in an alternative example, during the operation of the memory cell arrangement, e.g., soft information (e.g., soft decoded information read from the memory cells, e.g., using a kind of oversampling in reading the content of the memory cells) in the device may be monitored and may be used for selecting one or more available error correction circuits or for switching from one or more currently used error correction circuits to better suitable error correction circuits. Furthermore, in alternative examples, adaptive error correction processes or schemes may be provided. The adaptive error correction processes or schemes may be adapted to the maturity of the manufacturing process used, for example. Alternatively, the adaptive error correction processes or schemes may be adapted to predefined requirements such as e.g. predefined quality requirements.

In this example, four error correction processes and thus four failure classes 1806, 1808, 1810, 1812, are provided. In this example, the first failure class 1806 (which shows the least errors in the memory cells) is assigned to a first error correction process, e.g., a turbo code error correction process. Furthermore, the second failure class 1808 may include a memory cell arrangement having more or more severe and more difficult to correct errors and may be assigned to a second error correction process, e.g., a first BCH error correction process. Furthermore, the third failure class 1810 may include a memory cell arrangement having even more or more severe and more difficult to correct errors and may be assigned to a third error correction process, e.g. a second BCH error correction process, which may provide a higher error correction capability than the first BCH error correction process. Eventually, in this example, the fourth failure class 1812 may include a memory cell arrangement having the most or the most severe and/or most difficult to correct errors and may be assigned to a fourth error correction process, e.g., a Reed-Solomon error correction process. In an example, in case a memory cell arrangement is classified into one of the failure classes, the respectively assigned error correction process (implemented by a respective error correction circuit) is selected for being used for error correction when reading the content of the memory cells of the memory cell arrangement.

FIG. 19 shows a memory 124 of FIG. 1 in accordance with another embodiment. In this example, the memory 124 may include one or more memory cells 202, the controller 220 and in addition a plurality of error correction circuits 1902, 1904, 1906, each of which being configured to provide at least one error correction process such as, e.g., one error correction process as described above. The controller 220 may be configured to select none or at least one error correction circuit 1902, 1904, 1906, of the plurality of error correction circuits 1902, 1904, 1906, to be used for error correction when reading the memory cell 202. In this example, the error correction circuits 1902, 1904, 1906, may be integrated on the same die as the memory cells 202.

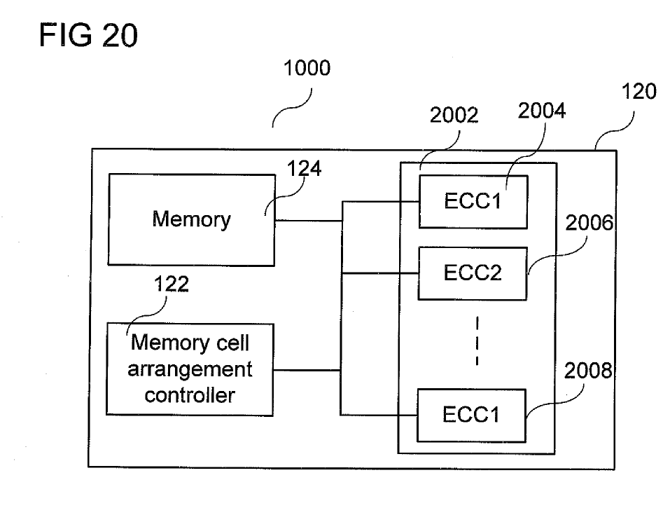

FIG. 20 shows a memory cell arrangement 120 of FIG. 1 in accordance with another embodiment. In this example, the memory cell arrangement 120 may include the memory 124, the memory cell arrangement controller 122 and, on the same die as the memory cell arrangement controller 122 or on a separate logic device (logic die) 2002, a plurality of error correction circuits 2004, 2006, 2008, each of which being configured to provide at least one error correction process such as e.g. one error correction process as described above. The memory cell arrangement controller 122 may be configured to select none or at least one error correction circuit 2004, 2006, 2008, of the plurality of error correction circuits 2004, 2006, 2008, to be used for error correction when reading the memory cell 202.

In an example, the information read from the memory cells may include soft information, which may be taken into account when selecting the one or more error correction circuits 1902, 1904, 1906, or 2004, 2006, 2008, to be used for error correction.

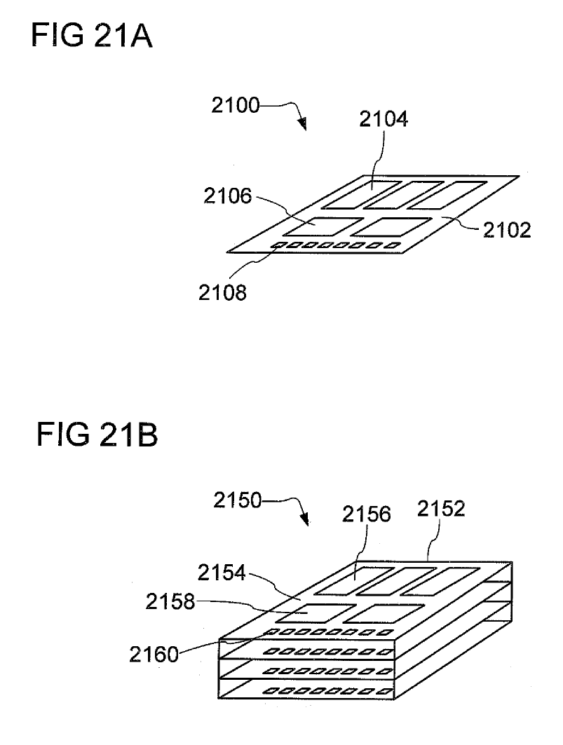

As shown in FIGS. 21A and 21B, in some embodiments, memory devices such as those described herein may be used in modules.

In FIG. 21A, a memory module 2100 is shown, on which one or more memory devices 2104 are arranged on a substrate 2102. The memory device 2104 may include numerous memory cells, each of which uses a memory element in accordance with an embodiment. The memory module 2100 may also include one or more electronic devices 2106, which may include memory, processing circuitry, control circuitry, addressing circuitry, bus interconnection circuitry, or other circuitry or electronic devices that may be combined on a module with a memory device, such as the memory device 2104. Additionally, the memory module 2100 includes multiple electrical connections 2108, which may be used to connect the memory module 2100 to other electronic components, including other modules.

As shown in FIG. 21B, in some embodiments, these modules may be stackable, to form a stack 2150. For example, a stackable memory module 2152 may contain one or more memory devices 2156, arranged on a stackable substrate 2154. The memory device 2156 contains memory cells that employ memory elements in accordance with an embodiment. The stackable memory module 2152 may also include one or more electronic devices 2158, which may include memory, processing circuitry, control circuitry, addressing circuitry, bus interconnection circuitry, or other circuitry or electronic devices that may be combined on a module with a memory device, such as the memory device 2156. Electrical connections 2160 are used to connect the stackable memory module 2152 with other modules in the stack 2150, or with other electronic devices. Other modules in the stack 2150 may include additional stackable memory modules, similar to the stackable memory module 2152 described above, or other types of stackable modules, such as stackable processing modules, control modules, communication modules, or other modules containing electronic components.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. An integrated circuit having a memory cell arrangement, the memory cell arrangement comprising:
at least one memory cell;
at least one error correction circuit; and
a controller configured to control a read operation to read state information from the at least one memory cell by reading a memory cell state information bypassing the at least one error correction circuit, or by reading the memory cell state information and supplying it to the at least one error correction circuit.

2. The integrated circuit of claim 1, further comprising at least one error detection circuit.

3. The integrated circuit of claim 1, wherein the at least one error correction circuit comprises a plurality of error correction circuits.

4. The integrated circuit of claim 3, wherein the plurality of error correction circuits are coupled with each other in series.

5. The integrated circuit of claim 4,
wherein an input of a first error correction circuit of the plurality of error correction circuits is configured to receive the read memory cell state information;
wherein an input of a second error correction circuit of the plurality of error correction circuits is configured to receive information representing the read memory cell state information; and
wherein the second error correction circuit has a higher error correction capability than the first error correction circuit.

6. The integrated circuit of claim 5, wherein the controller is configured to control the second error correction circuit to carry out an error correction process on the information representing the read memory cell state information in case the first error correction circuit is unable to correct an error in the read memory cell state information.

7. The integrated circuit of claim 2, wherein the controller is configured to determine as to whether to control the read operation to read state information from the at least one memory cell by reading the memory cell state information bypassing the at least one error correction circuit, or by reading the memory cell state information and supplying it to the at least one error correction circuit depending on an error detection signal provided by the at least one error detection circuit, wherein the error detection signal indicates as to whether the read state information comprises an error or not.

8. The integrated circuit of claim 1, wherein the at least one memory cell comprises at least one non-volatile memory cell.

9. The integrated circuit of claim 1, wherein the at least one memory cell comprises a plurality of memory cells being serially source-to-drain coupled with each other.

10. An integrated circuit having a memory cell arrangement, the memory cell arrangement comprising:
a memory cell;
an error correction circuit;
an output coupled to the memory cell and to the error correction circuit;
a first read path from the memory cell to the output bypassing the error correction circuit;
a second read path from the memory cell via the error correction circuit to the output;
a controller configured to control a read operation to read state information from the memory cell such that the read operation comprises:
a first read mode, in which the read state information is supplied to the output via the first read path; and
a second read mode, in which the read state information is supplied to the output via the second read path.

11. The integrated circuit of claim 10, further comprising at least one error detection circuit.

12. The integrated circuit of claim 10, further comprising a further error correction circuit coupled to the memory cell.

13. The integrated circuit of claim 12,
wherein an input of the first error correction circuit is configured to receive the read memory cell state information;
wherein an input of the further error correction circuit is configured to receive information representing the read memory cell state information; and
wherein the further error correction circuit has a higher error correction capability than the error correction circuit.

14. The integrated circuit of claim 13, wherein the controller is configured to control the further error correction circuit to carry out an error correction process on the information representing the read memory cell state information in case the error correction circuit is unable to correct an error in the read memory cell state information.

15. The integrated circuit of claim 11, wherein the controller is configured to determine as to whether to control the read operation to read state information from the memory cell by reading the memory cell state information bypassing the error correction circuit, or by reading the memory cell state information and supplying it to the error correction circuit depending on an error detection signal provided by the error detection circuit, wherein the error detection signal indicates as to whether the read state information comprises an error or not.

16. The integrated circuit of claim 10, wherein the memory cell comprises a non-volatile memory cell.

17. The integrated circuit of claim 10, wherein the memory cell comprises one memory cell of a plurality of memory cells the plurality of memory cells being serially source-to-drain coupled with each other.

18. An integrated circuit having a memory cell arrangement, the memory cell arrangement comprising:
a memory cell;
an error detection circuit;
an error correction circuit;
a controller configured to control a read operation to read state information from the memory cell by reading, in a first read mode, a memory cell state information bypassing the error correction circuit,
to determine, using the error detection circuit, whether the read memory cell state information fulfills a predefined criterion, and
depending on whether the read memory cell state information fulfills the predefined criterion, to remain in the first read mode, or to switch to a second read mode, in which the memory cell state information is read and supplied to the error correction circuit for error correction.

19. The integrated circuit of claim 18, wherein the predefined criterion comprises information about a number of programming cycles carried out on the memory cell arrangement or a part of the memory cell arrangement.

20. The integrated circuit of claim 18, wherein the predefined criterion comprises information about whether the error detection circuit detects an error in the read memory cell state information.

21. The integrated circuit of claim 20, further comprising a further error correction circuit.

22. The integrated circuit of claim 21, wherein the controller is further configured
to determine whether the read memory cell state information fulfills a further predefined criterion, and
depending on whether the read memory cell state information fulfills the further predefined criterion, to remain in the first read mode or the second read mode, or to switch to a third read mode, in which the memory cell state information is read and supplied to the further error correction circuit for error correction.

23. The integrated circuit of claim 20, wherein the further predefined criterion comprises information as to whether the error correction circuit is able to correct an error in the read memory cell state information.

24. A method for reading state information in a memory cell arrangement of an integrated circuit, the method comprising:
controlling a read operation to read the state information from at least one memory cell of the memory cell arrangement by reading memory cell state information bypassing at least one error correction circuit, or by reading the memory cell state information and supplying it to the at least one error correction circuit.

25. An integrated circuit having a memory cell arrangement, the memory cell arrangement comprising:
a memory cell;
a plurality of error correction circuits;
a controller configured to select an error correction circuit of the plurality of error correction circuits to be used for error correction when reading the memory cell.
